(19) United States
(12) Patent Application Publication
(10) Pub. No.: US 2016/0330697 A1
(43) Pub. Date: Nov. 10, 2016

(54) PHYSICAL UPLINK CONTROL CHANNEL MANAGEMENT FOR PUCCH SECONDARY CELL IN CARRIER AGGREGATION

(71) Applicant: QUALCOMM Incorporated, San Diego, CA (US)

(72) Inventors: Wanshi Chen, San Diego, CA (US); Madhavan Srinivasan Vajapeyam, San Diego, CA (US); Peter Gaal, San Diego, CA (US); Ozcan Ozturk, San Diego, CA (US)

(21) Appl. No.: 15/140,847

(22) Filed: Apr. 28, 2016

Related U.S. Application Data
(60) Provisional application No. 62/159,067, filed on May 8, 2015.

(51) Int. Cl. H04W 52/32; H04W 52/36; H04W 72/04

(52) U.S. Cl. CPC H04W 52/325; H04W 72/0413; H04W 52/365; H04W 72/0473; H04W 52/367

(57) ABSTRACT

Methods, systems, and devices for wireless communication are described. A user equipment (UE) may be configured for carrier aggregation (CA) configuration with a primary cell (PCell) and a physical uplink control channel (PUCCH) enabled secondary cell (SCell). The UE may receive a message to activate a deactivated PUCCH-enabled SCell and may perform a PUCCH power initialization procedure, which may include adjusting or determining a transmission power for an initial PUCCH transmission on the activated SCell. The UE may then transmit an initial PUCCH message on the SCell based on the PUCCH power initialization procedure. The PUCCH power initialization procedure may, in various examples, include applying a power adjustment factor to a PUCCH power control setting, monitoring a control channel format for a power control command, or transmitting a power headroom report (PHR) for the SCell at or before activation of the SCell.

### CROSS REFERENCES

The present application for patent claims priority to U.S. Provisional Patent Application No. 62/159,067 by Chen, et al., entitled “Physical Uplink Control Channel Management for PUCCH Secondary Cell in Carrier Aggregation,” filed May 8, 2015, assigned to the assignee hereof.

### BACKGROUND

The following relates generally to wireless communication, and more specifically to physical uplink control channel (PUCCH) management for a PUCCH-enabled secondary cell (SCell) in carrier aggregation (CA).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

In some cases, a UE may be configured for CA with multiple component carriers (CCs) that are arranged into different uplink control groups. Thus, both a primary cell (PCell) and an SCell may be configured with PUCCH that supports a group of cells. When the PUCCH-enabled SCell is activated, the UE may employ an insufficient uplink transmission power, which may result in lost or interrupted communication.

### SUMMARY

A user equipment (UE) may be configured for carrier aggregation (CA) with a primary cell (PCell) and a physical uplink control channel (PUCCH)-enabled secondary cell (SCell), and the PUCCH-enabled SCell may be in an activated or a deactivated state. Thus, unlike scenarios in which a PUCCH-enabled cell, such as a PCell, is always activated, the present disclosure describes systems in which a PUCCH-enabled cell may be deactivated and subsequently reactivated. Accordingly, a UE may receive an activation message for a deactivated PUCCH-enabled SCell, and the UE may perform a PUCCH power initialization procedure before transmitting uplink messages on the PUCCH-enabled SCell. The UE may then transmit an initial PUCCH message on the PUCCH-enabled SCell based on the PUCCH power initialization procedure. The PUCCH power initialization procedure may include applying a power adjustment factor to a PUCCH power control setting, monitoring a control channel format for power control commands, transmitting a power headroom report (PHR) for the SCell at or before the SCell is activated, or the like.

A method of wireless communication is described. The method may include establishing a CA configuration comprising a PCell and an SCell, the SCell configured with a PUCCH, receiving an activation message for the SCell configured with the PUCCH, performing a PUCCH power initialization procedure in response to the activation message based at least in part on the SCell being configured with the PUCCH, and transmitting an initial PUCCH message on the SCell based at least in part on the PUCCH power initialization procedure.

An apparatus for wireless communication is described. The apparatus may include means for establishing a CA configuration comprising a PCell and an SCell, the SCell configured with a PUCCH, means for receiving an activation message for the SCell configured with the PUCCH, means for performing a PUCCH power initialization procedure in response to the activation message based at least in part on the SCell being configured with the PUCCH, and means for transmitting an initial PUCCH message on the SCell based at least in part on the PUCCH power initialization procedure.

A further apparatus for wireless communication is described. The apparatus may include a processor, memory in electronic communication with the processor, and instructions stored in the memory and operable, when executed by the processor, to cause the apparatus to establish a CA configuration comprising a PCell and an SCell, the SCell configured with a PUCCH, receive an activation message for the SCell configured with the PUCCH, perform a PUCCH power initialization procedure in response to the activation message based at least in part on the SCell being configured with the PUCCH, and transmit an initial PUCCH message on the SCell based at least in part on the PUCCH power initialization procedure.

A non-transitory computer-readable medium storing code for wireless communication is described. The code may include instructions executable to establish a CA configuration comprising a PCell and an SCell, the SCell configured with a PUCCH, receive an activation message for the SCell configured with the PUCCH, perform a PUCCH power initialization procedure in response to the activation message based at least in part on the SCell being configured with the PUCCH, and transmit an initial PUCCH message on the SCell based at least in part on the PUCCH power initialization procedure.

In some examples of the method, apparatuses, or non-transitory computer-readable medium described herein, performing the PUCCH power initialization procedure comprises applying a power adjustment factor to a PUCCH power control setting. Additionally or alternatively, some examples may include processes, features, means, or instructions for receiving a power adjustment message indicative of the power adjustment factor in a medium access control (MAC) coverage enhancement (CE), a physical downlink shared channel (PDSCH) transmission, a physical downlink control channel (PDCCH) transmission, or an enhanced physical downlink control channel (ePDCCH) transmission or any combination thereof.

Some examples of the method, apparatuses, or non-transitory computer-readable medium described herein may further include processes, features, means, or instructions for selecting the power adjustment factor from a plurality of power adjustment factors. Additionally or alternatively, in some examples the power adjustment factor is predetermined.

Some examples of the method, apparatuses, or non-transitory computer-readable medium described herein may further include processes, features, means, or instructions for removing the power adjustment factor from the PUCCH power control setting, and transmitting a second PUCCH based at least in part on the removal of the power adjustment factor. Additionally or alternatively, in some examples performing the PUCCH power initialization procedure comprises monitoring at least one control channel format for power control commands for the initial PUCCH on the SCell at or before the SCell is activated.

In some examples of the method, apparatuses, or non-transitory computer-readable medium described herein, the at least one control channel format comprises a downlink control information (DCI) format 3 or a DCI format 3A, or both. Additionally or alternatively, some examples may include processes, features, means, or instructions for monitoring the control channel format at or before the SCell is activated.

In some examples of the method, apparatuses, or non-transitory computer-readable medium described herein, performing the PUCCH power initialization procedure comprises transmitting a power headroom report (PHR) for the SCell at or before the SCell is activated. Additionally or alternatively, in some examples the PHR is transmitted during a reconfiguration procedure for the SCell based at least in part on an activation state of the SCell.

Some examples of the method, apparatuses, or non-transitory computer-readable medium described herein may further include processes, features, means, or instructions for transmitting a PHR prior to receiving the activation message. Additionally or alternatively, in some examples the activation message is received as part of a reconfiguration procedure for the SCell.

A method of wireless communication is described. The method may include establishing a CA configuration comprising a PCell and an SCell, the SCell configured with a PUCCH, transmitting an activation message for the SCell configured with the PUCCH, performing a PUCCH power initialization procedure subsequent to the activation message based at least in part on the S Cell being configured with the PUCCH, and receiving an initial PUCCH message on the SCell based at least in part on the PUCCH power initialization procedure.

An apparatus for wireless communication is described. The apparatus may include means for establishing a CA configuration comprising a PCell and an SCell, the SCell configured with a PUCCH, means for transmitting an activation message for the SCell configured with the PUCCH, means for performing a PUCCH power initialization procedure subsequent to the activation message based at least in part on the SCell being configured with the PUCCH, and means for receiving an initial PUCCH message on the SCell based at least in part on the PUCCH power initialization procedure.

A further apparatus for wireless communication is described. The apparatus may include a processor, memory in electronic communication with the processor, and instructions stored in the memory and operable, when executed by the processor, to cause the apparatus to establish a CA configuration comprising a PCell and an SCell, the SCell configured with a PUCCH, transmit an activation message for the SCell configured with the PUCCH, perform a PUCCH power initialization procedure subsequent to the activation message based at least in part on the SCell being configured with the PUCCH, and receive an initial PUCCH message on the SCell based at least in part on the PUCCH power initialization procedure.

A non-transitory computer-readable medium storing code for wireless communication is described. The code may include instructions executable to establish a CA configuration comprising a PCell and an SCell, the SCell configured with a PUCCH, transmit an activation message for the SCell configured with the PUCCH, perform a PUCCH power initialization procedure subsequent to the activation message based at least in part on the SCell being configured with the PUCCH, and receive an initial PUCCH message on the SCell based at least in part on the PUCCH power initialization procedure.

In some examples of the method, apparatuses, or non-transitory computer-readable medium described herein, performing the PUCCH power initialization procedure comprises transmitting a power control command for the SCell. Additionally or alternatively, in some examples the power control command is transmitted utilizing DCI format 3, DCI format 3A, a MAC CE, a PDSCH, a PDCCH, an ePDCCH, or any combination thereof.

In some examples of the method, apparatuses, or non-transitory computer-readable medium described herein, the power control command is based at least in part on a received power or a path loss, or both. Additionally or alternatively, in some examples performing the PUCCH power initialization procedure comprises receiving a PHR report at or before the SCell is activated.

### BRIEF DESCRIPTION OF THE DRAWINGS

Aspects of the disclosure are described in reference to the following figures:

FIG. 1 illustrates an example of a wireless communications system that supports activation and deactivation for physical uplink control channel (PUCCH)-enabled secondary cell (SCell) in carrier aggregation (CA) in accordance with various aspects of the present disclosure;

FIG. 2 illustrates an example of a wireless communications system that supports activation and deactivation for a PUCCH-enabled SCell in CA in accordance with various aspects of the present disclosure;

FIGS. 3A and 3B illustrates examples of activation timing for a PUCCH-enabled SCell in CA in accordance with various aspects of the present disclosure;

FIG. 4 illustrates aspects of PUCCH management for an SCell in CA in accordance with the present disclosure;

FIGS. 5-7 show block diagrams of a wireless device or devices that support operation of a PUCCH-enabled SCell in CA in accordance with various aspects of the present disclosure;

FIG. 8 illustrates a block diagram of a system, including a user equipment (UE) that supports use of a PUCCH-SCell in CA in accordance with various aspects of the present disclosure;

FIGS. 9-11 show block diagrams of a wireless device or devices that supports use of a PUCCH-enabled SCell in CA in accordance with various aspects of the present disclosure;

FIG. 12 illustrates a block diagram of a system, including a base station that supports management of a PUCCH-enabled SCell in CA in accordance with various aspects of the present disclosure; and

FIGS. 13-20 illustrate methods for management of a PUCCH SCell in CA in accordance with various aspects of the present disclosure.

### DETAILED DESCRIPTION

In some wireless systems, a user equipment (UE) can be configured with a number of component carriers (CC) for carrier aggregation (CA) operation. One CC can be configured as the primary CC (PCC) or primary cell (PCell) for the UE and all other CCs may be termed secondary CCs (SCC) or secondary cells (SCells). Certain functions can be designated to the PCC, e.g., the physical uplink control channel (PUCCH) and the common search space. Depending upon configuration, functions typically designated to only the PCC are also carried on another CC. For example, in some systems, a secondary cell can be configured to carry PUCCH in addition to the PCC. Such SCells may be referred to as a PUCCH-enabled SCell or PSCell. This type of configuration (e.g., a configuration with a PUCCH-enabled SCell) can achieve improved performance, e.g., for PUCCH load balancing.

Secondary cells can be deactivated or activated. This may be a faster way to manage a set of CCs than other forms of signaling, such as radio resource control (RRC) reconfiguration. If a cell is activated, the PUCCH or the physical uplink shared channel (PUSCH) may be subject to power controls, such as open-loop and closed-loop power control. Uplink power control may be improved by the UE sending a power headroom report (PHR), which indicates how much headroom the UE has relative to its maximum transmit power.

A PUCCH-enabled SCell may be deactivated upon initial configuration and, correspondingly, there may be no UL transmission. Similarly, an activated PUCCH-enabled SCell may be deactivated and reactivated at a later point. As a result, the PUCCH transmit power for PUCCH transmissions on the PUCCH-enabled SCell may not be correctly set upon activation, and it may be desirable to perform a power initialization procedure to ensure proper power control for initial PUCCH transmissions. For example, upon activation, a power adjustment can be applied for PUCCH power control of the PUCCH SCell. The power adjustment can be pre-defined or signaled. Alternatively, monitoring of the control channel (e.g., DCI format 3/3A) on the PCell for power control commands for the SCell PUCCH may be initiated prior to activation. Additionally or alternatively, the PHR can be triggered prior to activation.

Similar scenarios do not typically exist in carrier aggregation or dual-connectivity. For example, a PCell in a CA configuration is not typically deactivated, and so there is little concern that an initial PUCCH transmission would be sent with insufficient power. Likewise, in a dual-connectivity configuration, the PCell of a secondary cell group would not typically be deactivated and thus would not give rise to concerns about initial PUCCH transmission power. It is the activation from a deactivated state of a PUCCH-enabled SCell that, in some cases, may cause an initial transmit power of the PUCCH transmission to be insufficient if proper measures or adjustments are not employed.

Aspects of the disclosure are initially described below in the context of a wireless communication system. Specific examples are then described for PUCCH management in the context of PUCCH-enabled SCell activation timing. These and other aspects of the disclosure are further illustrated by and described with reference to apparatus diagrams, system diagrams, and flowcharts that relate to PUCCH management for a PUCCH-enabled SCell in CA.

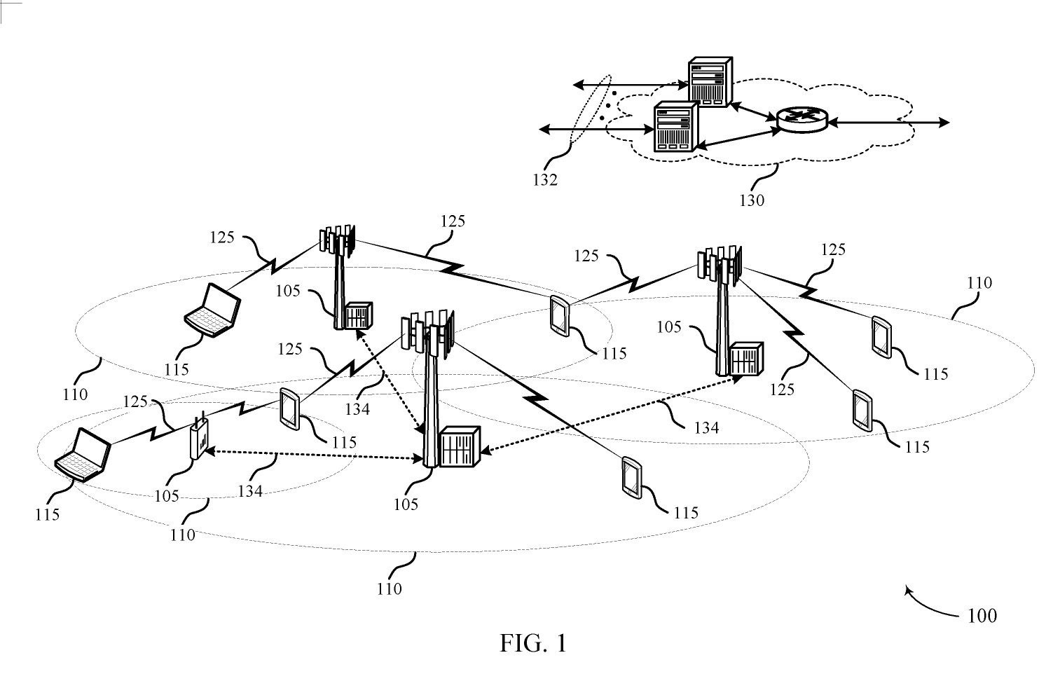

FIG. 1 illustrates an example of a wireless communications system 100 in accordance with various aspects of the present disclosure. The wireless communications system 100 includes base stations 105, user equipment (UEs) 115, and a core network 130. In some examples, the wireless communications system 100 may be a Long Term Evolution (LTE)/LTE-Advanced (LTE-A) network. Wireless communications system 100 may include a UE 115 that utilizes uplink control channels on more than one serving cell (which may be supported by more than one base station 105).

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal, a handset, a user agent, a client, or some other suitable terminology. A UE 115 may also be a cellular phone, a wireless modem, a handheld device, a personal computer, a tablet, a personal electronic device, a machine type communication (MTC) device or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

A communication link 125 may include one or more frequency ranges organized into carriers. A carrier may also be referred to as a CC, a layer, a channel, etc. The term “component carrier” may refer to each of the multiple carriers utilized by a UE in carrier aggregation (CA) operation, and may be distinct from other portions of system bandwidth. For instance, a component carrier may be a relatively narrow-bandwidth carrier susceptible of being utilized independently or in combination with other component carriers. Each component carrier may provide the same capabilities as an isolated carrier based on release 8 or release 9 of the Long LTE standard. Multiple component carriers may be aggregated or utilized concurrently to provide some UEs 115 with greater bandwidth and higher data rates. Thus, individual component carriers may be backwards compatible with legacy UEs 115 (e.g., UEs 115 implementing LTE release 8 or release 9); while other UEs 115 (e.g., UEs 115 implementing post-release 8/9 LIE versions), may be configured with multiple component carriers in a multi-carrier mode. A carrier used for downlink (DL) may be referred to as a DL CC, and a carrier used for uplink (UL) may be referred to as an UL CC. A UE 115 may be configured with multiple DL component carriers (CCs) and one or more UL CCs for carrier aggregation. Each carrier may be used to transmit control information (e.g., reference signals, control channels, etc.), overhead information, data, etc. A UE 115 may communicate with a single base station 105 utilizing multiple carriers, and may also communicate with multiple base stations simultaneously on different carriers.

Each cell of a base station 105 may include an UL component carrier (CC) and a DL CC. The geographic coverage area 110 of each serving cell for a base station 105 may be different (e.g., CCs on different frequency bands may experience different path loss). In some examples, one carrier is designated as the primary carrier, or primary component carrier (PCC), for a UE 115, which may be served by a primary cell (PCell). Primary cells may be semi-statically configured by higher layers (e.g., radio resource control (RRC), etc.) on a per-UE basis. Certain uplink control information (UCI) (e.g., acknowledgement (ACK)/negative ACK (NACK)), channel quality indicator (CQI), and scheduling information transmitted on physical uplink control channel (PUCCH), are carried by the primary cell. Additional carriers may be designated as secondary carriers, or secondary component carriers (SCC), which may be served by secondary cells (SCells). Secondary cells may likewise be semi-statically configured on a per-UE basis. In some cases, secondary cells may not include or be configured to transmit a PUCCH; such control channel transmissions may instead be carried by the primary cell. In other cases, and as discussed above, one or more SCells may be configured to carry PUCCH, and the SCells may be organized into PUCCH groups based on which CC is used to carry the associated UL control information. Some wireless networks may utilize enhanced CA operations based on a large number of carriers (e.g., between 5 and 32 carriers), operation in unlicensed spectrum, or use of enhanced CCs. When CCs are configured (e.g., using radio resource control (RRC) signaling), the SCells may initially be in a deactivated state. A base station 105 may then activate an SCell prior to using it for data communication.

Downlink control information (DCI) may be conveyed in a physical downlink control channel (PDCCH). PDCCH carries downlink control information (DCI) in control channel elements (CCEs), which may consist of nine logically contiguous resource element groups (REGs), where each REG contains 4 resource elements (REs). DCI includes information regarding DL scheduling assignments, UL resource grants, transmission scheme, UL power control (e.g., in DCI format 3/3A), hybrid automatic repeat request (HARQ) information, modulation and coding scheme (MCS) and other information. The size and format of the DCI messages can differ depending on the type and amount of information that is carried by the DCI. For example, if spatial multiplexing is supported, the size of the DCI message is large compared to contiguous frequency allocations. Similarly, for a system that employs multiple input multiple output (MIMO), the DCI must include additional signaling information. DCI size and format depend on the amount of information as well as factors such as bandwidth, the number of antenna ports, and duplexing mode.

PDCCH can carry DCI messages associated with multiple users, and each UE 115 may decode the DCI messages that are intended for it. For example, each UE 115 may be assigned a cell radio network temporary identity (C-RNTI) and cyclic redundancy check (CRC) bits attached to each DCI may be scrambled based on the C-RNTI. To reduce power consumption and overhead at the user equipment, a limited set of CCE locations can be specified for DCI associated with a specific UE 115. CCEs may be grouped (e.g., in groups of 1, 2, 4 and 8 CCEs), and a set of CCE locations in which the user equipment may find relevant DCI may be specified. These CCEs may be known as a search space. The search space can be partitioned into two regions: a common CCE region or search space and a UE-specific (dedicated) CCE region or search space. The common CCE region is monitored by all UEs served by a base station 105 and may include information such as paging information, system information, random access procedures and the like. The UE-specific search space may include user-specific control information. CCEs may be indexed, and the common search space may start from CCE 0. The starting index for a UE specific search space depends on the C-RNTI, the subframe index, the CCE aggregation level and a random seed. A UE 115 may attempt to decode DCI by performing a process known as blind decoding, during which a set of decoding candidates is checked for control channel messages. During a blind decode, the UE 115 may attempt descramble all potential DCI messages using its C-RNTI and perform a CRC check to determine whether the attempt was successful.

Uplink control information may be conveyed in a PUCCH, which, as discussed above, may enabled on a PCell and one or more SCells of a CA configuration. PUCCH may be used for UL acknowledgements (ACKs), scheduling requests (SRs), channel quality indicators (CQI), and other UL control information. A PUCCH may be mapped to a control channel defined by a code and two consecutive resource blocks. UL control signaling may depend on the presence of timing synchronization for a cell. PUCCH resources for scheduling request (SR) and channel quality indicator (CQI) reporting may be assigned (and revoked) through radio resource control (RRC) signaling. In some cases, resources for SR may be assigned after acquiring synchronization through a random access channel (RACH) procedure. In other cases, an SR may not be assigned to a UE 115 through the RACH (i.e., synchronized UEs may or may not have a dedicated SR channel). PUCCH resources for SR and CQI may be lost when the UE is no longer synchronized.

A UE 115 may coordinate transmit power with a serving base station to mitigate interference, improve the UL data rate, and prolong battery life. Uplink power control may include a combination of open-loop and closed-loop mechanisms. In open-loop power control the UE transmit power depends on estimates of the downlink path-loss and channel configuration. In closed-loop power control the network can directly control the UE transmit power using explicit power-control commands. Open-loop power control may be used for initial access, whereas both open and closed loop control may be used for UL control and data transmission. A UE 115 may determine TX power using an algorithm that takes into account a maximum transmission power limit, a target base station receive power, path loss, modulation and coding scheme (MCS), the number of resources used for transmission, and the format of the transmitted data (e.g., PUCCH format). Power adjustments may be made by a base station 105 using a transmit power command (TPC) message, which may incrementally adjust the transmit power of a UE 115 as appropriate.

Some control information (both for uplink and downlink) may be conveyed in a media access control (MAC) control element (CE) (i.e., in the MAC header), of a shared channel packet (i.e., a data packet). For example, a UE 115 may transmit a power headroom report (PHR) to a base station in an uplink MAC CE. The PHR may indicate that a UE 115 may have additional transmission power available for current UL transmissions, for example.

Accordingly, a UE 115 may be configured for CA with a PCell and a PUCCH-enabled SCell. The UE 115 may receive an activation message for the SCell and may perform a PUCCH power initialization procedure. The UE115 may then transmit an initial PUCCH message on the SCell based on the PUCCH power initialization procedure. The PUCCH power initialization procedure may include applying a power adjustment factor to a PUCCH power control setting, monitoring a control channel format for power control commands, and transmitting a PHR for the SCell at or before the SCell is activated.

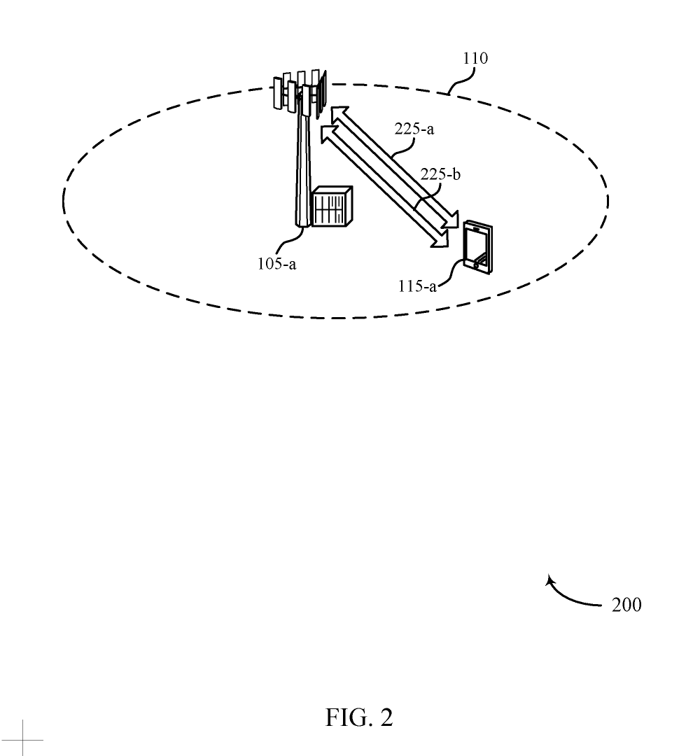

FIG. 2 illustrates an example of a wireless communications system 200 for PUCCH management for a PUCCH-enabled SCell in CA in accordance with various aspects of the present disclosure. Wireless communications system 200 may include a UE 115-a and base station 105-a, which may be examples of a UE 115 base station 105 described with reference to FIG. 1.

UE 115-a may be configured with multiple CCs 225 for CA operation. For example, each CC 225 may include a frequency range of up to 20 MHz (i.e., for a total of 100 MHz). The different CCs 225 may be supported by a single base station (e.g., base station 105-a) or they can be supported by multiple base stations. CCs 225 in a CA configuration may be all frequency division duplexing (FDD), all time division duplexing (TDD), or a mixture of FDD and TDD. Different TDD CCs 225 may have the same or different downlink/uplink (DL/UL) configurations. Some subframes can also be configured differently for different TDD CCs 225.

One CC 225 can be configured as PCell 225-a for UE 115-a and all other CCs 225 are termed SCells for UE 115-a with respect to carrier aggregation at node 105. Certain functions can be designated to only PCell 225-a, for example, the PUCCH and the common search space for UE 115-a at base station 105-a. In some cases, a UL control channel is also configured for a secondary cell in carrier aggregation. For example, a PUCCH can be enabled for a secondary cell of base station 105-a. Similarly, in a dual-connectivity context, carrier aggregation with respect to a second node may likewise include PUCCH on the primary cell as well as one or more secondary cells of the second node. This can achieve improved performance and PUCCH load balancing, for instance.

CCs 225 may have non-negligible latency over backhaul 134 (e.g., tens of milliseconds) or limited backhaul bandwidth that can limit the degree of coordination between cells. Wireless communications system 200 may utilize techniques to overcome this, for example, using dual-connectivity procedures. In dual connectivity, cells are partitioned into two groups: the primary cell group (PCG) and the secondary cell group (SCG). Each group can have one or more cells in CA and each group has a single cell carrying PUCCH. The primary cell in the PCG carries PUCCH for the PCG and a secondary cell in the SCG carries PUCCH for the SCG (also called the PSCell). The common search space is also monitored in SCG by UE 115-a. Uplink control information is separately conveyed to each group via the PUCCH in each group.

In some cases, SCell 225-b can be deactivated or activated. This may provide a faster way to manage the set of CCs 225 serving UE 115-a than, for example, a RRC reconfiguration. If SCell 225-b is being activated, UE 115-a typically applies normal SCell operation, which may include: sounding reference signal (SRS) transmissions on the SCell; reporting that may include channel quality indicator (CQI), pre-coding matrix indicator (PMI), rank indicator (RI), and procedure transaction identity (PTI); monitoring the physical downlink control channel (PDCCH); start or restart the cell deactivation timer associated with the SCell; and trigger the power headroom report (PHR).

If SCell 225-b is deactivated, UE 115-a may discontinue some actions for SCell 225-b, which may include transmitting SRS, reporting CQI/PMI/RI/PTI for the SCell, transmitting on the uplink shared channel (UL-SCH) on the SCell, transmitting on the random access channel (RACH) on the SCell, monitoring the PDCCH on the SCell, and monitoring the PDCCH for SCell 225-b. When UE 115-a receives a deactivation command for SCell 225-b or if the cell deactivation timer associated with SCell 225-b expires in subframe n, the corresponding actions for deactivation may be applied no later than the minimum.

The transmission of uplink control information (UCI) may depend on if a SCell 225-b is in use or not. For example, if PUCCH is limited to PCell 225-a, all UCI may be transmitted through PCell 225-a. If PUCCH is enabled on SCell 225-b in addition to PCell 225-a, then UCI may be transmitted on a per cell group basis.

In wireless communications system 200, uplink transmissions may be subject to power control. For example, the PUCCH or the PUSCH may be subject to power controls such as open-loop and closed-loop power control. Open-loop power control may be in the form of a set of RRC configured power control parameters, some per cell and some per UE 115.

Closed-loop power control may be in the form of a power control loop where the power control commands (e.g., TPC commands) are received by UE 115-a, updated, and returned to PCell 225-a (or SCell 225-b). For example, these power control commands may be sent via unicast DCI, where DL grants carry power control commands for PUCCH for UE 115-a and UL grants carry power control commands for PUSCH for UE 115-a, or they may also be sent via group DCI in DCI formats 3/3A. In the latter example, if dual-PUCCH is in use, DCI formats 3/3A in the common search space of the PCell 225-a can also carry power control commands for the SCell 225-b. This may be in the form of an index in DCI formats 3/3A, or also, for example, by transmit power control radio network temporary identifier (TPC RNTI) for the PUCCH SCell, or a combination thereof.

After UE 115-a receives the power control command, it may update the corresponding power control loop based on the received power control commands, which may be subject to a certain timing relationship.

In some cases, management of uplink operation by the base station may be improved by UE 115-a sending a power headroom report (PHR), which may indicate how much headroom UE 115-a has relative to its maximum transmit power. To satisfy some power thresholds, such as performance or leakage standards, the maximum transmit power may be subject to some power reduction. This power reduction may depend on multiple parameters, including the combinations of uplink channels in a subframe, the size or location of each channel, the transmit power of each channel, the number of power amplifiers at UE 115-a, etc. In some cases, if UE 115-a does not transmit a PUCCH or PUSCH, UE 115-a may report PHR based on some reference formats. For example, for PUSCH PHR (type 1 PHR), the reference format may be 1-resource block (RB) PUSCH, no maximum power reduction, etc. For PUCCH PHR (type 2 PHR), the reference format may be PUCCH format 1a, no maximum power reduction, etc.

In wireless communications system 200, the timing of activation of CCs 225 may depend upon the implementation of UE 115-a. Accordingly, the base station 105-a may not know when UE 115-a will transmit PUCCH on the SCell 225-b. Because SCell 225-b may be deactivated before being activated and, correspondingly, there may be no UL transmission, the PUCCH transmit power for the initial PUCCH transmissions on the SCell 225-b may be insufficient or inaccurately set upon activation.

The PUCCH initial transmit power may be set based on the last used transmit power. For example, the power control loop for PUCCH for SCell 225-b may be frozen if it is deactivated. Upon activation, UE 115-a can determine PUCCH power control based on the last power control loop setting. However, if the PUCCH power is too low, base station 105-a may not know in sufficient time when SCell 225-b is fully activated, and performance loss may occur for all cells associated with the SCell 225-b (i.e., cells in the PUCCH group). In some cases, transmit power could be too high and interfere with other neighboring cells. In some cases, the base station may rely on long-term measurements, such as reference signal received power (RSRP) or reference single received quality (RSRQ), to estimate UL channel change during the deactivation period of SCell 225-b. However, such measurements are long-term and may be insufficient for PUCCH management on SCell 225-b.

When SCell 225-b is deactivated, its closed-loop power control function may be kept frozen. Upon activation, a power adjustment, ΔP, can be applied for PUCCH power control in addition to restoring the last power control loop setting. The additional power adjustment can be pre-defined or signaled. For example, a single pre-defined value can be applied, e.g., ΔP=3 dB, or multiple values can be pre-defined. In the latter case, the values could depend on the deactivation duration of SCell 225-b. For example, if the deactivation duration of SCell 225-b is 100 ms or less, ΔP=3 dB; otherwise, ΔP=6 dB. A signaled power adjustment could be part of the activation procedure (e.g., in the medium access control element (MAC CE)), part of PDSCH payload, or in the PDCCH or the enhanced physical downlink control channel (EPDCCH). The application of ΔP can be for one or more initial PUCCH transmissions, but then removed later on. Alternatively, it can be applied to all PUCCH transmissions on SCell 225-b. Furthermore, base station 105-a can update and provide a new value upon activation and each re-activation, where the default value may be 0 dB.

The monitoring of the control channel (e.g., DCI format 3/3A) on the PCell for power control commands for PUCCH of SCell 225-b may be different from other control channel monitoring. However, DCI format 3/3A monitoring may start early such that the base station can transmit power control commands to the power control PUCCH of SCell 225-b even when SCell 225-b is not fully activated yet. Alternatively, DCI format 3/3A monitoring on the PCell for SCell 225-b can be performed even if SCell 225-b is deactivated, but generally, such requirements may not be necessary. UE 115-a may process these DCI format 3/3A power commands as usual.

Additionally or alternatively, a PHR for SCell 225-b can be triggered early. For example, base station 105-a may schedule PUSCH transmission for UE 115-a in order to have in-time PHR reports. Additionally or separately, the PHR may be triggered and reported for SCell 225-b even when SCell 225-b is deactivated.

Generally speaking, when its PCell is reconfigured, a UE 115 may treat the re-configuration as a handover event. But when a PUCCH SCell is reconfigured, UE 115-a may treat the re-configuration as an RRC re-configuration. In order to facilitate PUCCH management on SCell 225-b, the PHR may be triggered as part of the re-configuration, even if the newly configured PUCCH-enabled SCell is still deactivated. In this situation, the base stations 105 can then rely on the PHR report to better manage PUCCH power on SCell 225-b, especially for the initial transmissions. A power adjustment parameter may also be used for power control of the PUCCH transmissions on the PUCCH SCell. Alternatively, the PHR triggering upon PUCCH SCell re-configuration may be dependent on the SCell activation state. For example, if the deactivated SCell is re-configured with PUCCH the PHR may not be triggered. Or if the activated SCell is re-configured with PUCCH the PHR may be triggered.

In some cases, the base stations 105 may not have any uplink information concerning SCell 225-b, and therefore may not have information regarding the preferred transmit power. This may lead to extra actions, such as sending one or more power up commands, which may depend on the duration of deactivation. If base station 105-a or 105-a does have some information, however, such as an updated reference signal received power (RSRP), the base station 105 may use that as the input to update DCI format 3/3A or the power adjustment.

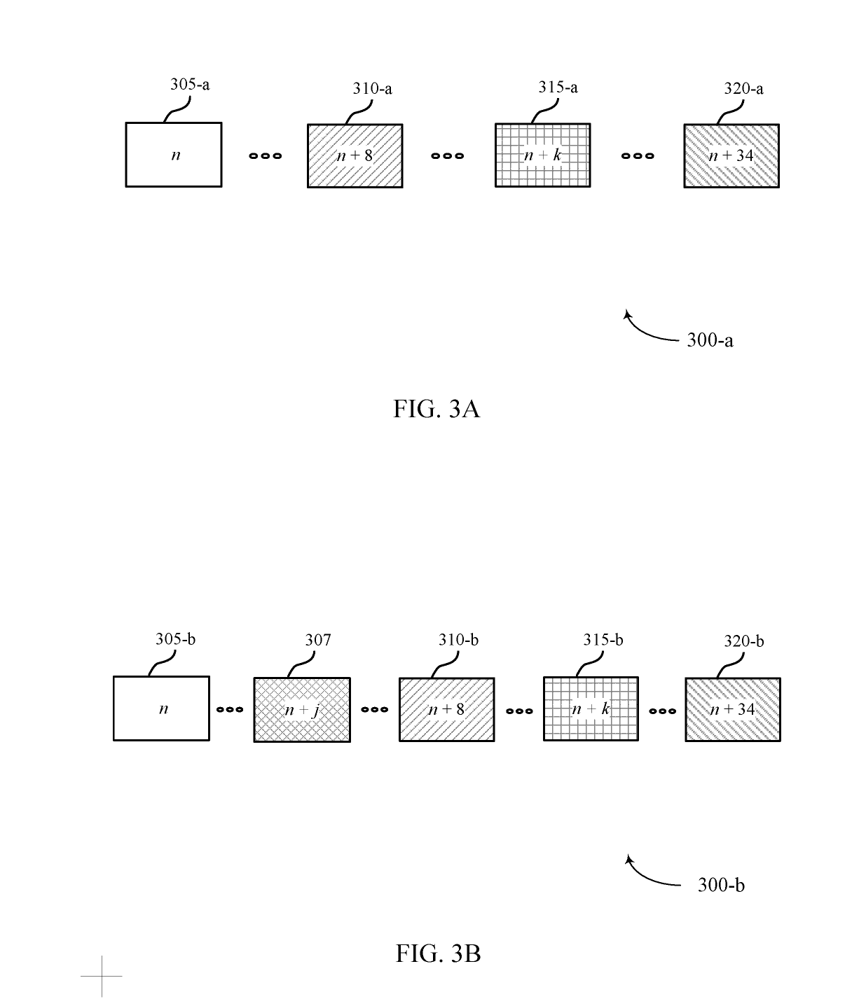

FIG. 3A illustrates an example of a PUCCH SCell activation timing 300-a that supports PUCCH management for a PUCCH-enabled SCell in CA in accordance with various aspects of the present disclosure. PUCCH SCell activation timing 300-a may represent the timing for activation of an SCell for a UE 115 and base station 105 as described with reference to FIGS. 1 and 2. In some cases, the time periods represented in PUCCH SCell activation timing 300-a may be 1 ms subframes, but in other cases they may be based on other time periods.

In the example of FIG. 3A, initial time period 305-a represents a starting point for activating a PUCCH-enabled SCell (e.g., the time when a UE 115 receives an SCell activation command from a base station 105).

Time period 310-a may represent a time period in which an activation procedure is initiated. For example, UE 115 may transmit a CSI report and initiate a deactivation timer. In some cases, this process may begin at a predetermined time following reception of the activation command. For example, the activation may be initiated 8 ms (or 8 subframes) following reception of the activation message. Thus, as used herein, “activation procedure” may refer to the sequence of events relating to activation of a PUCCH-enabled SCell. For instance, the “activation procedure” may include a UE 115 receiving an activation command and the steps the UE 115 takes after receiving an activation command.

Time period 315-a may represent a time period in which UE 115 implements the activation procedure for the PUCCH-enabled SCell. That is, time period 315-a may be the time when a PUCCH-enabled SCell is activated. For example, once activation is complete, UE 115 may monitor PDCCH on the PUCCH SCell, transmit SRS, transmit PUCCH, trigger a PHR, etc. As used herein, the PUCCH-enabled SCell is referred to as “activated” or “fully activated” at subframe (n+k) when normal operation including monitoring PDCCH, sending SRS, triggering PHR, etc., is possible following a transition from the deactivated state. Similarly, the period after an activation command is received, but prior to full activation of the PUCCH-enabled SCell at subframe (n+k) is deemed “before activation,” or more generally that the PUCCH-enabled SCell is “not yet activated.”

Time period 320-a may represent the time period in which the activation of the PUCCH SCell is specified to be completed by UE 115 after receipt of the activation command from the base station 105. This time period may be bounded, for example, at 34 ms (or 34 subframes) following reception of the activation message. The time period 320-a may be specified by, for instance, a wireless communication standards, such as the LTE standard.

When a UE 115 receives an activation command at subframe n, it should perform the corresponding actions for activation at subframe (n+k), where subframe (n+k) is no later than the minimum requirement. For example, some systems may utilize a 34 ms minimum (n+34). In some cases, a PUCCH-enabled SCell may be activated no earlier than subframe (n+8) (or some other designated time period). In some cases, some actions can occur in subframe (n+8). For example, the actions related to channel state information (CSI) reporting and actions related to the cell deactivation timer associated with a PUCCH-enabled SCell can occur in subframe (n+8). When a UE 115 receives an activation command, the activation subframe (n+k) is dependent upon UE-implementation. While deactivated, or before activation, it does not monitor the control channel for the cell being activated, nor report PHR to the cell being activated, nor transmit SRS on the cell being activated until subframe (n+k), where k≧8 ms, but ≦34 ms.

A power control command in a DCI in subframe n may be applied in subframe (n+m), where m for PUCCH is the same as the downlink hybrid automatic repeat request (HARQ) timing or, in the case of the PDSCH, is the same as the corresponding HARQ acknowledgment. In the case of PUSCH, in this example, m is the same as the UL scheduling timing (from UL grant to the corresponding PUSCH transmission).

When an SCell is deactivated and it then receives an activation command (e.g., in subframe n, until subframe (n+k)), some actions may not be performed. For example, no PHR may be triggered for a PUCCH-enabled SCell, and no DL control channel monitoring on or for a PUCCH-enabled SCell. In addition, UL PUSCH transmission may happen at (n+k+4), assuming a at least 4 ms UL scheduling timing, and DL PDSCH transmission on a PUCCH-enabled SCell may happen at (n+k). Thus, an SCell may be activated after a delay of less than 34 ms (n+34), except for the actions related to CSI reporting and starting of a deactivation timer that are applied in subframe (n+8). When a PUCCH-enabled SCell is activated or deactivated, it may be different than the PCell 225-a in the PCG and the PSCell in dual-connectivity, which are always activated. If a PUCCH-enabled SCell is activated or re-activated in subframe n, UE 115-a may be able to transmit PUCCH in any subframe between (n+8) and (n+34).

FIG. 3B illustrates an example of a PUCCH SCell activation timing 300-b for PUCCH management for a PUCCH-enabled SCell in CA in accordance with various aspects of the present disclosure. PUCCH SCell activation timing 300-b may represent the timing for activation of an SCell for a UE 115 and base station 105 as described with reference to FIGS. 1 and 2. In some cases, the time periods represented in PUCCH SCell activation timing 300-b may be 1 ms subframes, but in other cases they may be based on other time periods.

Initial time period 305-b represents a starting point for activating a PUCCH-enabled SCell (e.g., the time when a UE 115 receives an SCell activation command from a base station 105).

Time period 307 may represent the time period in which UE 115 performs a power initialization procedure. For example, this power initialization procedure may involve UE 115 triggering a PHR to send to base station 105. In some cases, the power initialization procedure involves UE 115 monitoring for power control commands (e.g., using DCI format 3/3A), or UE 115 may apply a power adjustment factor to an uplink power control setting. Additionally or alternatively, the power initialization procedure may begin at a predetermined time following reception of the activation command but occurs before the time period for initiation of the PUCCH SCell activation. For example, the power initialization procedure may begin at 4 ms (or 4 subframes) but before 8 ms (or 8 subframes) following reception of the activation message.

Time period 310-b may represent a portion of an activation procedure. For example, UE 115 may transmit a CSI report and initiate a deactivation timer. In some cases, this process may begin at a predetermined time following reception of the activation command. For example, the CSI reporting and timer may be initiated 8 ms (or 8 subframes) following reception of the activation message.

Time period 315-b may represent a time period in which UE 115 completes the activation procedure for the PUCCH-enabled SCell. For example, UE 115 may monitor PDCCH on the PUCCH SCell, transmit SRS, transmit PUCCH, trigger a PHR, etc. This process may begin after the activation procedure is initiated (time period 310-b) but before the minimum requirement, for example, 34 ms.

Time period 320-b may represent the time by which the activation of the PUCCH SCell must be completed by UE 115 after receipt of the activation command from the base station 105 regardless of implementation. This time period may be predetermined, for example, at 34 ms (or 34 subframes) following reception of the activation message.

Thus, the monitoring of the control channel (e.g., DCI format 3/3A) on the PCell for power control commands for PUCCH of a PUCCH-enabled SCell may be different from other control channel monitoring, which begins at subframe (n+k) upon receipt of the activation command at subframe n. However, DCI format 3/3A monitoring may start from, for example, subframe (n+j), where j<k or possibly j<8, such that the base station can transmit power control commands to the power control PUCCH of a PUCCH-enabled SCell even when a PUCCH-enabled SCell is not fully activated yet. Alternatively, DCI format 3/3A monitoring on the PCell for a PUCCH-enabled SCell can be performed even if the S Cell is deactivated, but generally, such requirements may not be necessary. The UE 115 may process these DCI format 3/3A power commands as usual.

Additionally or alternatively, a PHR for a PUCCH-enabled SCell can be triggered early (e.g., earlier than subframe (n+k)). For other SCells without PUCCH, the PHR may be triggered as usual (e.g., at subframe (n+k)), where the value of k may be cell dependent. For a PUCCH-enabled SCell, the PHR can be triggered at an earlier subframe, for example, subframe (n+j). In some cases, the actual transmission of the PHR may be in subframe (n+j) or later. For example, base station 105-a may schedule PUSCH transmission for UE 115-a in order to have in-time PHR reports. Additionally or separately, the PHR may be reported for a PUCCH-enabled SCell even when the SCell is deactivated.

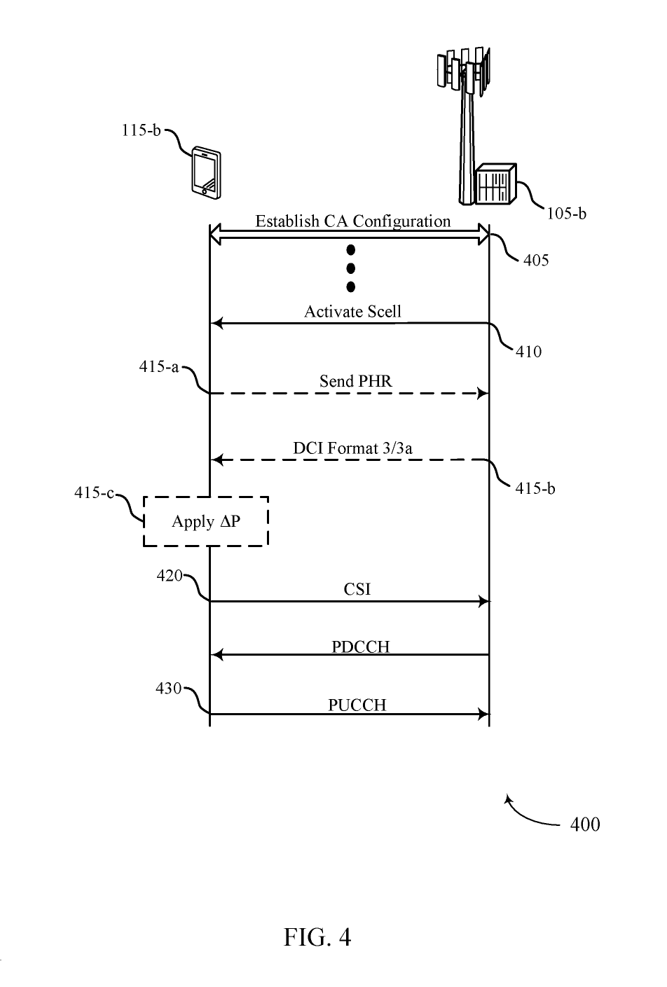

FIG. 4 illustrates an example of a process flow 400 for PUCCH management for a PUCCH SCell in CA in accordance with various aspects of the present disclosure. Process flow 400 may include a UE 115-b and base station 105-b, which may be examples of a UE 115 and base station 105 described with reference to FIGS. 1-2. Base station 105-b may support a PCell and a PUCCH-enabled SCell of UE 115-b. In some cases, base station 105-b may be a small cell. In some cases, the PUCCH-enabled SCell may be supported by a different base station 105.

At 405, UE 115-b and base station 105-b may establish a CA configuration including a PCell and a PUCCH-enabled SCell (PSCell). UE 115-b may establish a CA configuration including a primary cell (PCell) and an SCell, the SCell configured with a PUCCH.

At 410, UE 115-b may receive an activation message from base station 105-b for the SCell configured with the PUCCH.

At 415, UE 115-b and base station 105-b may perform a PUCCH power initialization procedure. For example, at 415-a, UE 115-b may monitor the control channel format at or before the SCell is activated and transmit a power headroom report (PHR) for the SCell at or before the SCell is activated. In some cases, the period at or before the SCell is activated may refer to a period prior to an initial activation CSI report, prior to initiating a deactivation timer, or prior to monitoring a control channel of the SCell.

In some examples, the PHR may be transmitted during a reconfiguration procedure for the SCell. In another example, UE 115-b may transmit a PHR prior to receiving the activation message, where the activation message is received as part of a reconfiguration procedure for the SCell.

As another example, at 415-b, UE 115-b may perform a PUCCH power initialization procedure by monitoring at least one control channel format for power control commands for the initial PUCCH on the SCell at or before the SCell is activated. For example, the at least one control channel format includes a DCI format 3 or a DCI format 3A, or both. Thus, in some examples performing the PUCCH power initialization procedure includes transmitting a power control command for the SCell. In some examples the power control command is transmitted utilizing DCI format 3, DCI format 3A, a MAC CE, a PDSCH, a PDCCH, an ePDCCH, or any combination thereof. In some examples the power control command is based on a received power or a path loss, or both. In some examples performing the PUCCH power initialization procedure includes receiving a PHR report at or before the SCell is activated.

As another example, at 415-c, UE 115-b may perform a PUCCH power initialization procedure by applying a power adjustment factor to an uplink power control setting. For example, UE 115-b may receive a power adjustment message indicative of the power adjustment factor in a medium access control (MAC) coverage enhancement (CE), a physical downlink shared channel (PDSCH) transmission, a physical downlink control channel (PDCCH) transmission, or an enhanced physical downlink control channel (ePDCCH) transmission or any combination thereof. Or UE 115-b may select the power adjustment factor from a plurality of power adjustment factors. Or the power adjustment factor may be predetermined. UE 115-b may also remove the power adjustment factor from the PUCCH power control setting and UE 115-b may transmit a second PUCCH based on the removal of the power adjustment factor. UE 115-b may thus determine a power activation level based on a transmission power level associated with a prior PUCCH transmission on the SCell and adjust the power activation level in accordance with a power adjustment factor.

At 420, UE 115-b may initiate the activation of the PSCell (e.g., by transmitting a channel state information (CSI) report for the PSCell). At 425, UE 115-b may receive a downlink transmission (e.g., a PDCCH transmission which may be followed by a PDSCH transmission) from base station 105-b over the PSCell.

At 430, UE 115-b may send an uplink transmission (e.g., a PUCCH in response to the downlink transmission) to base station 105-b over the PSCell. In some cases, base station 105-b may receive an initial PUCCH message on the SCell based on the PUCCH power initialization procedure.

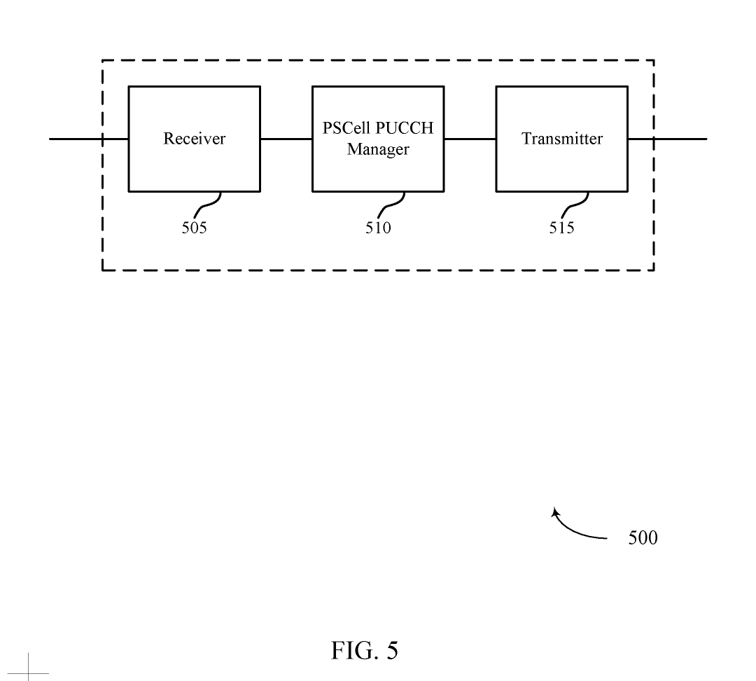

FIG. 5 shows a block diagram of a wireless device 500 that supports PUCCH management for a PUCCH-enabled SCell in CA in accordance with various aspects of the present disclosure. Wireless device 500 may be an example of aspects of a UE 115 described with reference to FIGS. 1-4. Wireless device 500 may include a receiver 505, a PSCell PUCCH manager 510, or a transmitter 515. Wireless device 500 may also include a processor. Each of these components may be in communication with each other.

The receiver 505 may receive information such as packets, user data, or control information associated with various information channels (e.g., control channels, data channels, and information related to PUCCH management for a PUCCH SCell in CA, etc.). Information may be passed on to the PSCell PUCCH manager 510, and to other components of wireless device 500.

The PSCell PUCCH manager 510 may establish a CA configuration including a PCell and an SCell, the SCell configured with a PUCCH, receive an activation message for the SCell configured with the PUCCH, perform a PUCCH power initialization procedure in response to the activation message based on the SCell being configured with the PUCCH, and transmit an initial PUCCH message on the SCell based on the PUCCH power initialization procedure.

The transmitter 515 may transmit signals received from other components of wireless device 500. In some examples, the transmitter 515 may be collocated with the receiver 505 in a transceiver module. The transmitter 515 may include a single antenna, or it may include a plurality of antennas. In some examples, the transmitter 515 may transmit an initial PUCCH message on the SCell based on a PUCCH power initialization procedure. In some examples, the transmitter 515 may transmit a second PUCCH based on the removal of the power adjustment factor.

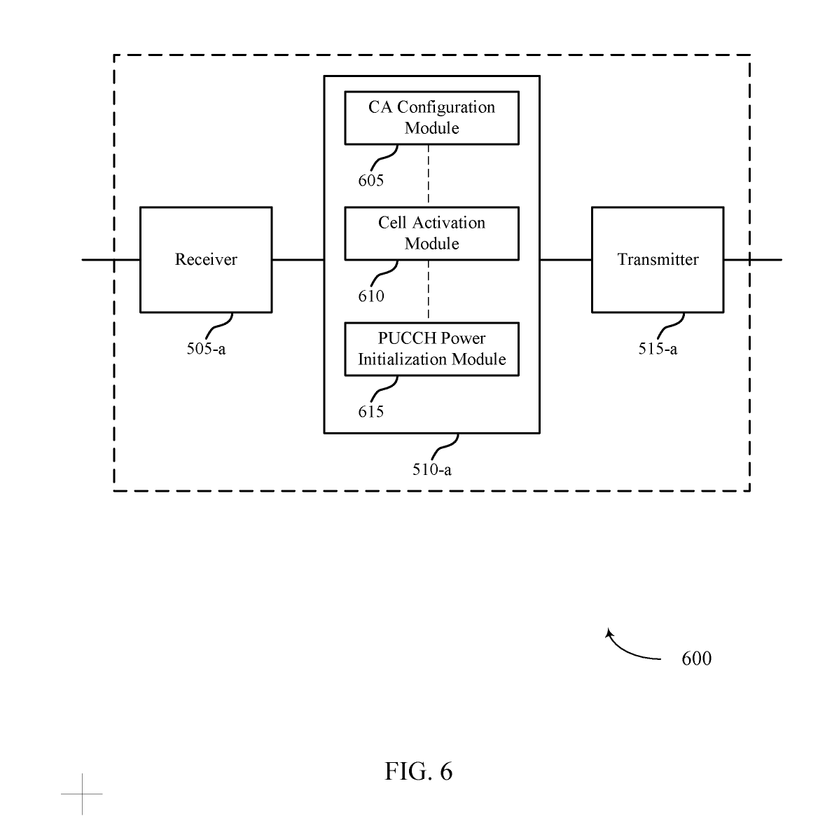

FIG. 6 shows a block diagram of a wireless device 600 for PUCCH management for a PUCCH SCell in CA in accordance with various aspects of the present disclosure. Wireless device 600 may be an example of aspects of a wireless device 500 or a UE 115 described with reference to FIGS. 1-5. Wireless device 600 may include a receiver 505-a, a PSCell PUCCH manager 510-a, or a transmitter 515-a. Wireless device 600 may also include a processor. Each of these components may be in communication with each other. The PSCell PUCCH manager 510-a may also include a CA configuration module 605, a cell activation module 610, and a PUCCH power initialization module 615.

The receiver 505-a may receive information which may be passed on to PSCell PUCCH manager 510-a, and to other components of wireless device 600. The PSCell PUCCH manager 510-a may perform the operations described with reference to FIG. 5. The transmitter 515-a may transmit signals received from other components of wireless device 600.

The CA configuration module 605 may establish a CA configuration including a PCell and an SCell, the SCell configured with a PUCCH as described with reference to FIGS. 2-4.

The cell activation module 610 may receive an activation message for the SCell configured with the PUCCH as described with reference to FIGS. 2-4. In some examples, the activation message may be received as part of a reconfiguration procedure for the SCell.

The PUCCH power initialization module 615 may perform a PUCCH power initialization procedure in response to the activation message based on the SCell being configured with the PUCCH as described with reference to FIGS. 2-4.

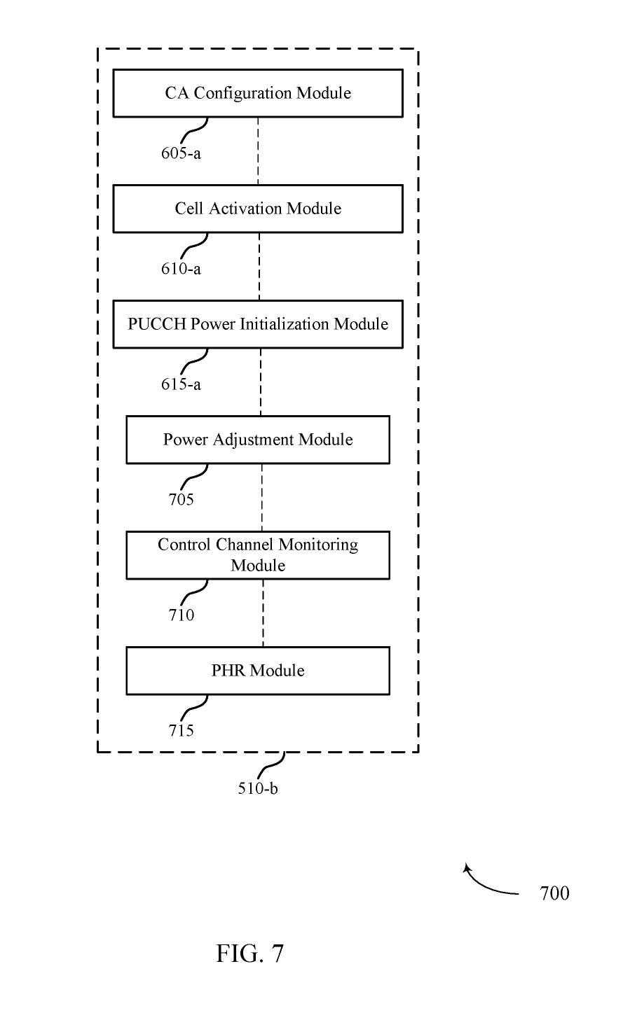

FIG. 7 shows a block diagram 700 of a PSCell PUCCH manager 510-b which may be a component of a wireless device 500 or a wireless device 600 that supports PUCCH management for a PUCCH-enabled SCell in CA in accordance with various aspects of the present disclosure. The PSCell PUCCH manager 510-b may be an example of aspects of a PSCell PUCCH manager 510 described with reference to FIGS. 5 and 6. The PSCell PUCCH manager 510-b may include a CA configuration module 605-a, a cell activation module 610-a, and a PUCCH power initialization module 615-a. Each of these modules may perform the functions described with reference to FIG. 6. The PSCell PUCCH manager 510-b may also include a power adjustment module 705, a control channel monitoring module 710, and a PHR module 715.

The power adjustment module 705 may support performing the PUCCH power initialization procedure, which may include applying a power adjustment factor to a PUCCH power control setting as described with reference to FIGS. 2-4. The power adjustment module 705 may also receive a power adjustment message indicative of the power adjustment factor in a MAC CE, a PDSCH transmission, a PDCCH transmission, or an ePDCCH transmission or any combination thereof. The power adjustment module 705 may also select the power adjustment factor from a plurality of power adjustment factors. In some cases, the power adjustment module 705 may adjust a power activation level in accordance with a power adjustment factor. In some examples, the power adjustment factor may be predetermined. The power adjustment module 705 may also remove the power adjustment factor from the PUCCH power control setting. That is, in some examples, power adjustment module 705 may facilitate transmitting a PUCCH message on an SCell at a transmission power that is independent of a power adjustment factor.

The control channel monitoring module 710 may support a PUCCH power initialization procedure that includes monitoring at least one control channel format for power control commands for the initial PUCCH on the SCell at or before the SCell is activated as described with reference to FIGS. 2-4. In some examples, the at least one control channel format includes a DCI format 3 or a DCI format 3A, or both. The control channel monitoring module 710 may also monitor the control channel format at or before the SCell is activated. In some cases, the control channel monitoring module 710 may determine a power activation level based on a transmission power level associated with prior PUCCH transmission on an SCell.

The PHR module 715 may support performing a PUCCH power initialization procedure that includes transmitting a PHR for the SCell at or before the SCell is activated as described with reference to FIGS. 2-4. In some examples, the PHR may be transmitted during a reconfiguration procedure for the SCell based on an activation state of the SCell. The PHR module 715 may also transmit a PHR prior to receiving the activation message.

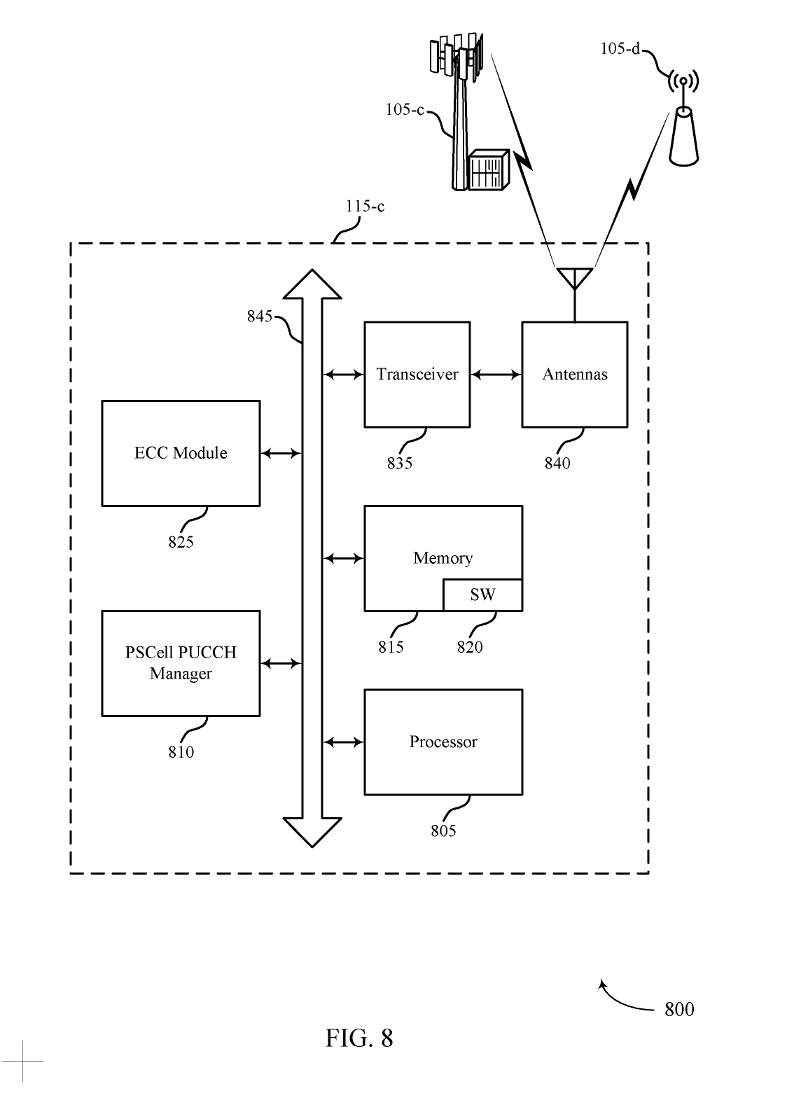

FIG. 8 shows a diagram of a system 800 including a UE 115 that supports PUCCH management for a PUCCH-enabled SCell in CA in accordance with various aspects of the present disclosure. System 800 may include UE 115-c, which may be an example of a wireless device 500, a wireless device 600, or a UE 115 described with reference to FIGS. 1, 2 and 5-7. UE 115-c may include a PSCell PUCCH manager 810, which may be an example of a PSCell PUCCH manager 510 described with reference to FIGS. 5-7. UE 115-c may also include an enhanced component carrier (ECC) module 825. UE 115-c may also include components for bi-directional voice and data communications including components for transmitting communications and components for receiving communications. For example, UE 115-c may communicate bi-directionally with base station 105-c or base station 105-d.

ECC Module 825 may enable UE 115-c to operate according to ECC procedures. An ECC may be characterized by one or more features including: flexible bandwidth, variable length TTIs, and modified control channel configuration. In some cases, an ECC may be associated with a carrier aggregation configuration or a dual connectivity configuration (i.e., when multiple serving cells have a suboptimal backhaul link). An ECC may also be configured for use in unlicensed spectrum or shared spectrum (where more than one operator is licensed to use the spectrum). An ECC characterized by flexible bandwidth may include one or more segments that may be utilized by UEs 115 that are not capable of monitoring the whole bandwidth or prefer to use a limited bandwidth to conserve power.

In some cases, an ECC may utilize a variable TTI length, which may include use of a reduced or variable symbol duration. In some cases the symbol duration may remain the same, but each symbol may represent a distinct TTI. In some cases an ECC may include multiple hierarchical layers associated with the different TTI lengths. For example, TTIs at one hierarchical layer may correspond to uniform 1 ms subframes, whereas in a second layer, variable length TTIs may correspond to bursts of short duration symbol periods. In some cases, a shorter symbol duration may also be associated with increased subcarrier spacing.

Flexible bandwidth and variable TTIs may be associated with a modified control channel configuration (e.g., an ECC may utilize an ePDCCH for DL control information). For example, one or more control channels of an ECC may utilize FDM scheduling to accommodate flexible bandwidth use. Other control channel modifications include the use of additional control channels (e.g., for eMBMS scheduling, or to indicate the length of variable length UL and DL bursts), or control channels transmitted at different intervals. An ECC may also include modified or additional HARQ related control information.

UE 115-c may also include a processor 805, and memory 815 (including software (SW) 820), a transceiver 835, and one or more antenna(s) 840, each of which may communicate, directly or indirectly, with one another (e.g., via buses 845). The transceiver 835 may communicate bi-directionally, via the antenna(s) 840 or wired or wireless links, with one or more networks, as described above. For example, the transceiver 835 may communicate bi-directionally with a base station 105 or another UE 115. The transceiver 835 may include a modem to modulate the packets and provide the modulated packets to the antenna(s) 840 for transmission, and to demodulate packets received from the antenna(s) 840. While UE 115-c may include a single antenna 840, UE 115-c may also have multiple antennas 840 capable of concurrently transmitting or receiving multiple wireless transmissions.

The memory 815 may include random access memory (RAM) and read only memory (ROM). The memory 815 may store computer-readable, computer-executable software/firmware code 820 including instructions that, when executed, cause the processor 805 to perform various functions described herein (e.g., PUCCH management for a PUCCH SCell in CA, etc.). Alternatively, the software/firmware code 820 may not be directly executable by the processor 805 but cause a computer (e.g., when compiled and executed) to perform functions described herein. The processor 805 may include an intelligent hardware device, (e.g., a central processing unit (CPU), a microcontroller, an application specific integrated circuit (ASIC), etc.).

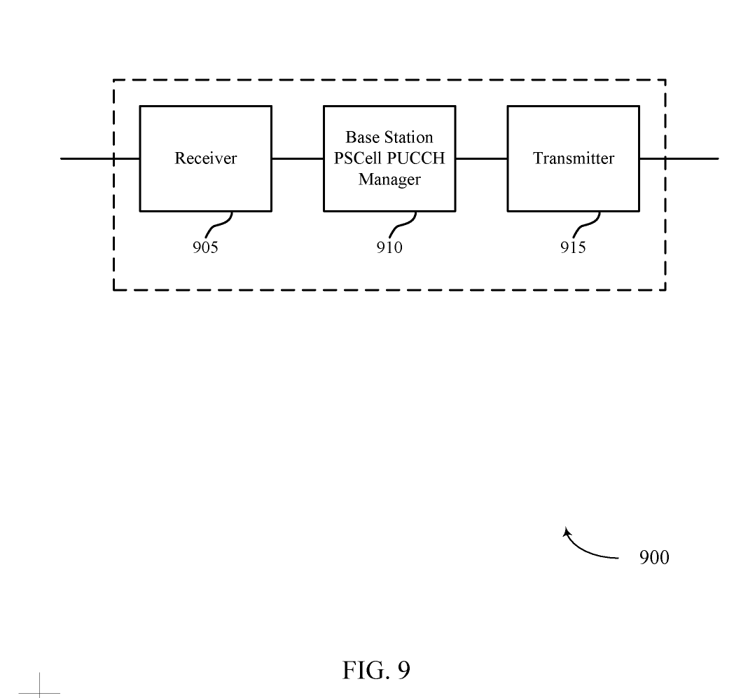

FIG. 9 shows a block diagram of a wireless device 900 that supports PUCCH management for a PUCCH-enabled SCell in CA in accordance with various aspects of the present disclosure. Wireless device 900 may be an example of aspects of a base station 105 described with reference to FIGS. 1-8. Wireless device 900 may include a receiver 905, a base station PSCell PUCCH manager 910, or a transmitter 915. Wireless device 900 may also include a processor. Each of these components may be in communication with each other.

The receiver 905 may receive information such as packets, user data, or control information associated with various information channels (e.g., control channels, data channels, and information related to PUCCH management for a PUCCH SCell in CA, etc.). Information may be passed on to the base station PSCell PUCCH manager 910, and to other components of wireless device 900. In some examples, the receiver 905 may receive an initial PUCCH message on the S Cell based on the PUCCH power initialization procedure.

The base station PSCell PUCCH manager 910 may establish a CA configuration including a PCell and an SCell, the SCell configured with a PUCCH, transmit an activation message for the SCell configured with the PUCCH, perform a PUCCH power initialization procedure subsequent to the activation message based on the SCell being configured with the PUCCH, and receive an initial PUCCH message on the SCell based on the PUCCH power initialization procedure.

The transmitter 915 may transmit signals received from other components of wireless device 900. In some examples, the transmitter 915 may be collocated with the receiver 905 in a transceiver module. The transmitter 915 may include a single antenna, or it may include a plurality of antennas.

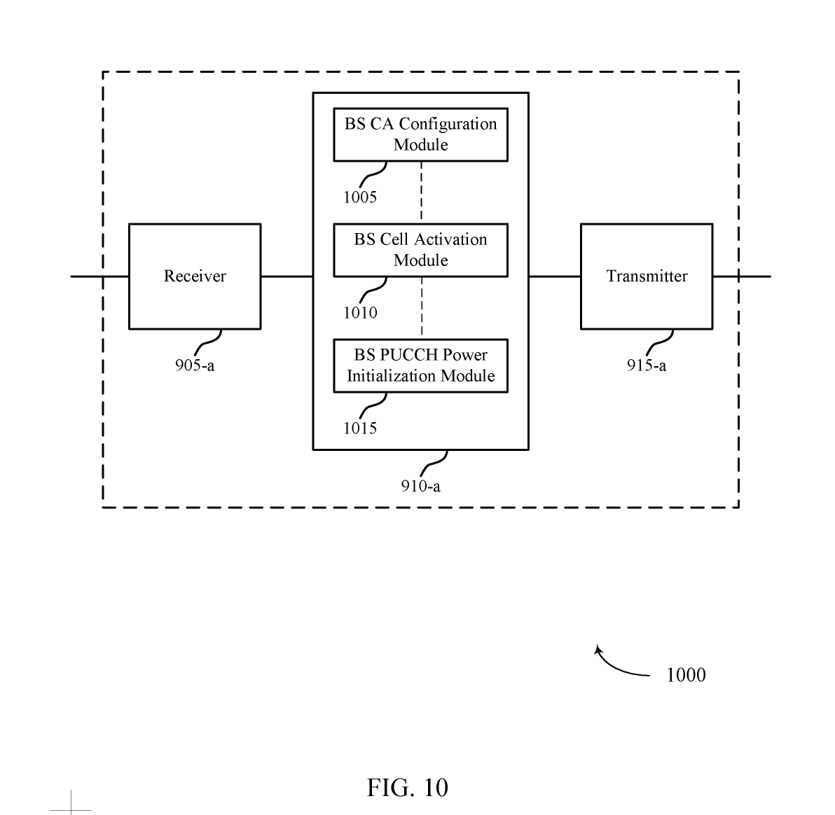

FIG. 10 shows a block diagram of a wireless device 1000 that supports PUCCH management for a PUCCH-enabled SCell in CA in accordance with various aspects of the present disclosure. Wireless device 1000 may be an example of aspects of a wireless device 900 or a base station 105 described with reference to FIGS. 1-9. Wireless device 1000 may include a receiver 905-a, a base station PSCell PUCCH manager 910-a, or a transmitter 915-a. Wireless device 1000 may also include a processor. Each of these components may be in communication with each other. The base station PSCell PUCCH manager 910-a may also include a BS CA configuration module 1005, a BS cell activation module 1010, and a BS PUCCH power initialization module 1015.

The receiver 905-a may receive information which may be passed on to base station PSCell PUCCH manager 910-a, and to other components of wireless device 1000. The base station PSCell PUCCH manager 910-a may perform the operations described with reference to FIG. 9. The transmitter 915-a may transmit signals received from other components of wireless device 1000.

The BS CA configuration module 1005 may establish a CA configuration including a PCell and an SCell, the SCell configured with a PUCCH as described with reference to FIGS. 2-4.

The BS cell activation module 1010 may transmit an activation message for the SCell configured with the PUCCH as described with reference to FIGS. 2-4.

The BS PUCCH power initialization module 1015 may perform a PUCCH power initialization procedure subsequent to the activation message based on the SCell being configured with the PUCCH as described with reference to FIGS. 2-4.

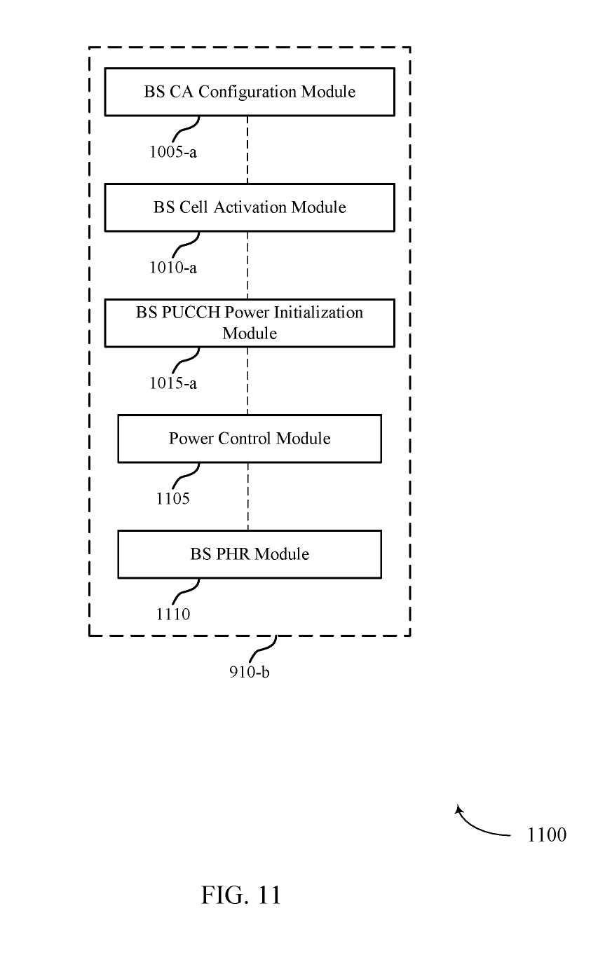

FIG. 11 shows a block diagram 1100 of a base station PSCell PUCCH manager 910-b which may be a component of a wireless device 900 or a wireless device 1000 for PUCCH management for a PUCCH SCell in CA in accordance with various aspects of the present disclosure. The base station PSCell PUCCH manager 910-b may be an example of aspects of a base station PSCell PUCCH manager 910 described with reference to FIGS. 9 and 10. The base station PSCell PUCCH manager 910-b may include a BS CA configuration module 1005-a, a BS cell activation module 1010-a, and a BS PUCCH power initialization module 1015-a. Each of these modules may perform the functions described with reference to FIG. 10. The base station PSCell PUCCH manager 910-b may also include a power control module 1105, and a BS PHR module 1110.

The power control module 1105 may support performing a PUCCH power initialization procedure that includes transmitting a power control command for the SCell as described with reference to FIGS. 2-4. In some examples, the power control command may be transmitted utilizing DCI format 3, DCI format 3A, a MAC CE, a PDSCH, a PDCCH, an ePDCCH, or any combination thereof. In some examples, the power control command may be based on a received power or a path loss, or both.

The BS PHR module 1110 may support performing a PUCCH power initialization procedure that includes receiving a PHR report at or before the SCell is activated as described with reference to FIGS. 2-4.

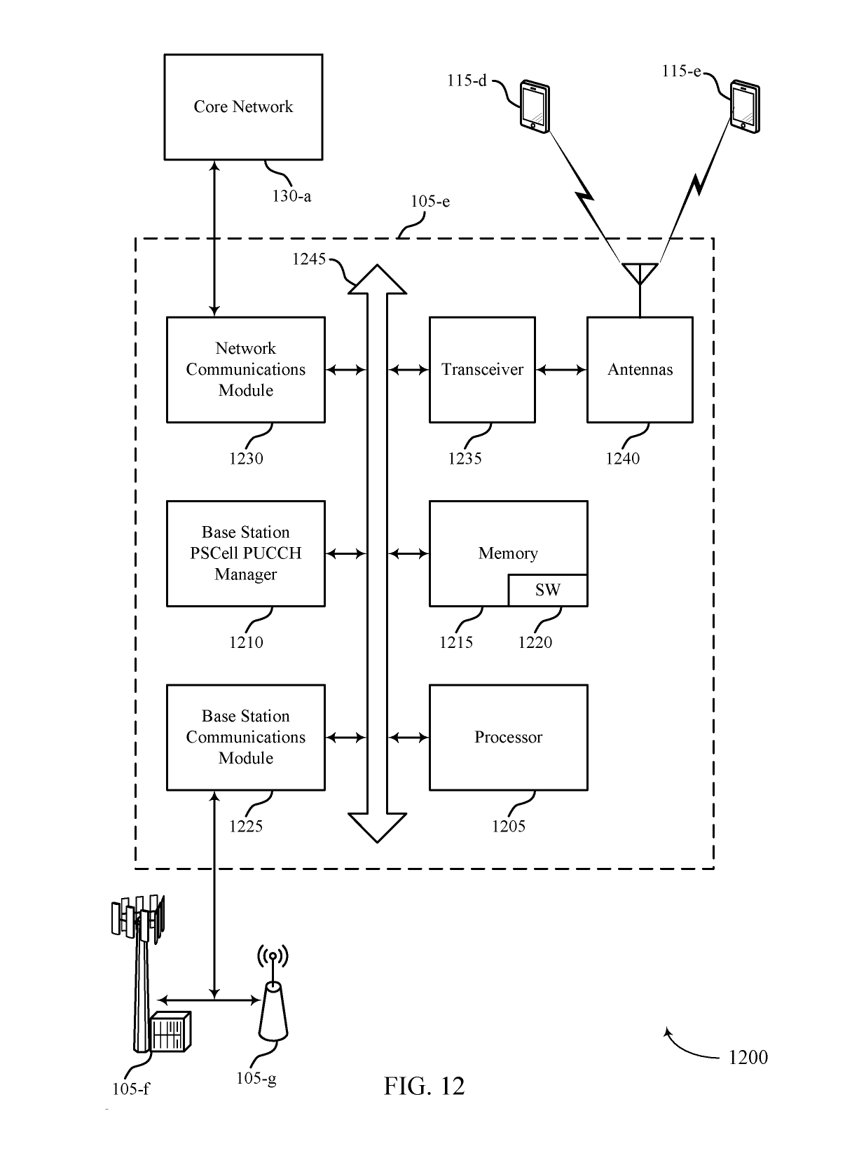

FIG. 12 shows a diagram of a system 1200 including a base station 105 that supports PUCCH management for a PUCCH-enabled SCell in CA in accordance with various aspects of the present disclosure. System 1200 may include base station 105-e, which may be an example of a wireless device 900, a wireless device 1000, or a base station 105 described with reference to FIGS. 1, 2 and 9-11. Base station 105-e may include a base station PSCell PUCCH manager 1210, which may be an example of a base station PSCell PUCCH manager 910 described with reference to FIGS. 9-11. Base station 105-e may also include components for bi-directional voice and data communications including components for transmitting communications and components for receiving communications. For example, base station 105-e may communicate bi-directionally with UE 115-d.

In some cases, base station 105-e may have one or more wired backhaul links. Base station 105-e may have a wired backhaul link (e.g., S1 interface, etc.) to the core network 130. Base station 105-e may also communicate with other base stations 105, such as base station 105-f and base station 105-g via inter-base station backhaul links (e.g., an X2 interface). Each of the base stations 105 may communicate with UEs 115 using the same or different wireless communications technologies. In some cases, base station 105-e may communicate with other base stations such as 105-f or 105-g utilizing base station communications module 1225. In some examples, base station communications module 1225 may provide an X2 interface within an LTE/LTE-A wireless communication network technology to provide communication between some of the base stations 105. In some examples, base station 105-e may communicate with other base stations through core network 130. In some cases, base station 105-e may communicate with the core network 130 through network communications module 1230.

The base station 105-e may include a processor 1205, memory 1215 (including software (SW) 1220), transceiver 1235, and antenna(s) 1240, which each may be in communication, directly or indirectly, with one another (e.g., over bus system 1245). The transceivers 1235 may be configured to communicate bi-directionally, via the antenna(s) 1240, with UEs 115, which may be multi-mode devices. The transceiver 1235 (or other components of the base station 105-e) may also be configured to communicate bi-directionally, via the antennas 1240, with one or more other base stations (not shown). The transceiver 1235 may include a modem configured to modulate the packets and provide the modulated packets to the antennas 1240 for transmission, and to demodulate packets received from the antennas 1240. The base station 105-e may include multiple transceivers 1235, each with one or more associated antennas 1240. The transceiver may be an example of a combined receiver 905 and transmitter 915 of FIG. 9.

The memory 1215 may include RAM and ROM. The memory 1215 may also store computer-readable, computer-executable software code 1220 containing instructions that are configured to, when executed, cause the processor 1205 to perform various functions described herein (e.g., PUCCH management for a PUCCH SCell in CA, selecting coverage enhancement techniques, call processing, database management, message routing, etc.). Alternatively, the software 1220 may not be directly executable by the processor 1205 but be configured to cause the computer when compiled and executed, to perform functions described herein. The processor 1205 may include an intelligent hardware device, e.g., a CPU, a microcontroller, an ASIC, etc. The processor 1205 may include various special purpose processors such as encoders, queue processing modules, base band processors, radio head controllers, digital signal processor (DSPs), and the like.

The base station communications module 1225 may manage communications with other base stations 105. In some cases, a communications management module may include a controller or scheduler for controlling communications with UEs 115 in cooperation with other base stations 105. For example, the base station communications module 1225 may coordinate scheduling for transmissions to UEs 115 for various interference mitigation techniques such as beamforming or joint transmission.

The components of wireless device 500, wireless device 600, and PSCell PUCCH manager 510, system 800, wireless device 900, wireless device 1000, BS PSCell PUCCH manager 910, and system 1200 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

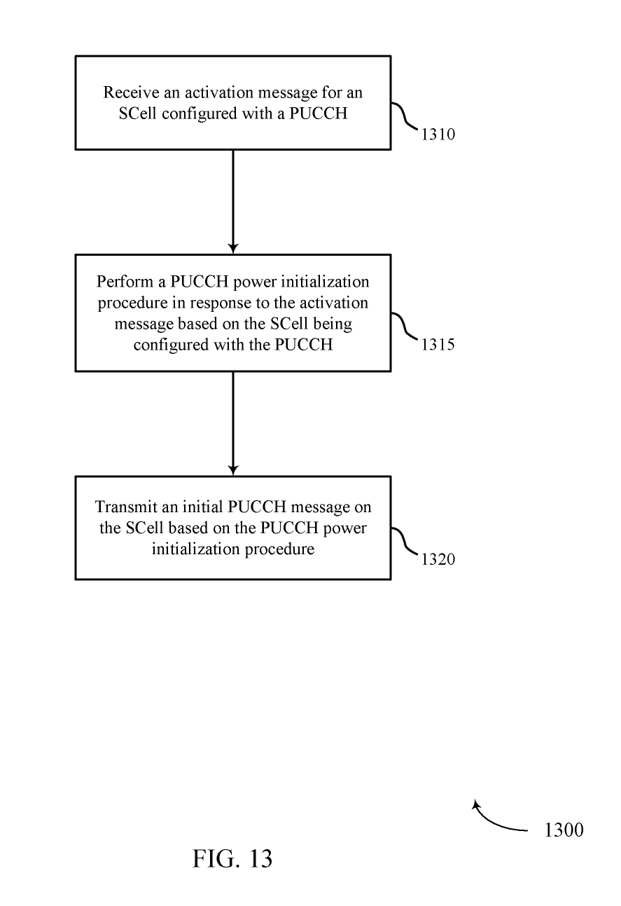

FIG. 13 shows a flowchart illustrating a method 1300 for PUCCH management for a PUCCH SCell in CA in accordance with various aspects of the present disclosure. The operations of method 1300 may be implemented by a UE 115 or its components as described with reference to FIGS. 1-12. For example, the operations of method 1300 may be performed by the PSCell PUCCH manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The UE 115 may establish or be configured for CA with a PCell and PUCCH-enabled SCell, as described with reference to FIGS. 2-4.

At block 1310, the UE 115 may receive an activation message for the SCell configured with the PUCCH as described with reference to FIGS. 2-4. In certain examples, the operations of block 1310 may be performed by the cell activation module 610 as described with reference to FIG. 6.

At block 1315, the UE 115 may perform a PUCCH power initialization procedure in response to the activation message based at least in part on the SCell being configured with the PUCCH as described with reference to FIGS. 2-4. In certain examples, the operations of block 1315 may be performed by the PUCCH power initialization module 615 as described with reference to FIG. 6.

At block 1320, the UE 115 may transmit an initial PUCCH message on the SCell based at least in part on the PUCCH power initialization procedure as described with reference to FIGS. 2-4. In certain examples, the operations of block 1320 may be performed by the transmitter 515 as described with reference to FIG. 5.

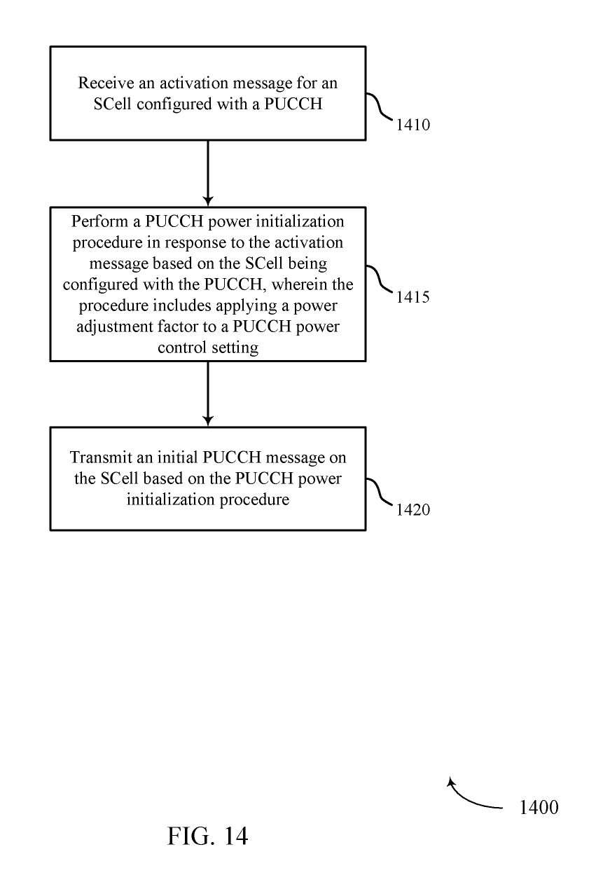

FIG. 14 shows a flowchart illustrating a method 1400 for PUCCH management for a PUCCH SCell in CA in accordance with various aspects of the present disclosure. The operations of method 1400 may be implemented by a UE 115 or its components as described with reference to FIGS. 1-12. For example, the operations of method 1400 may be performed by the PSCell PUCCH manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1400 may also incorporate aspects of method 1300 of FIG. 13. The UE 115 may establish or be configured for CA with a PCell and PUCCH-enabled SCell, as described with reference to FIGS. 2-4.

At block 1410, the UE 115 may receive an activation message for the SCell configured with the PUCCH as described with reference to FIGS. 2-4. In certain examples, the operations of block 1410 may be performed by the cell activation module 610 as described with reference to FIG. 6.

At block 1415, the UE 115 may perform a PUCCH power initialization procedure in response to the activation message based at least in part on the SCell being configured with the PUCCH as described with reference to FIGS. 2-4. In some cases, performing the PUCCH power initialization procedure includes: applying a power adjustment factor to a PUCCH power control setting. In certain examples, the operations of block 1415 may be performed by the PUCCH power initialization module 615 as described with reference to FIG. 6.

At block 1420, the UE 115 may transmit an initial PUCCH message on the SCell based at least in part on the PUCCH power initialization procedure as described with reference to FIGS. 2-4. In certain examples, the operations of block 1420 may be performed by the transmitter 515 as described with reference to FIG. 5.

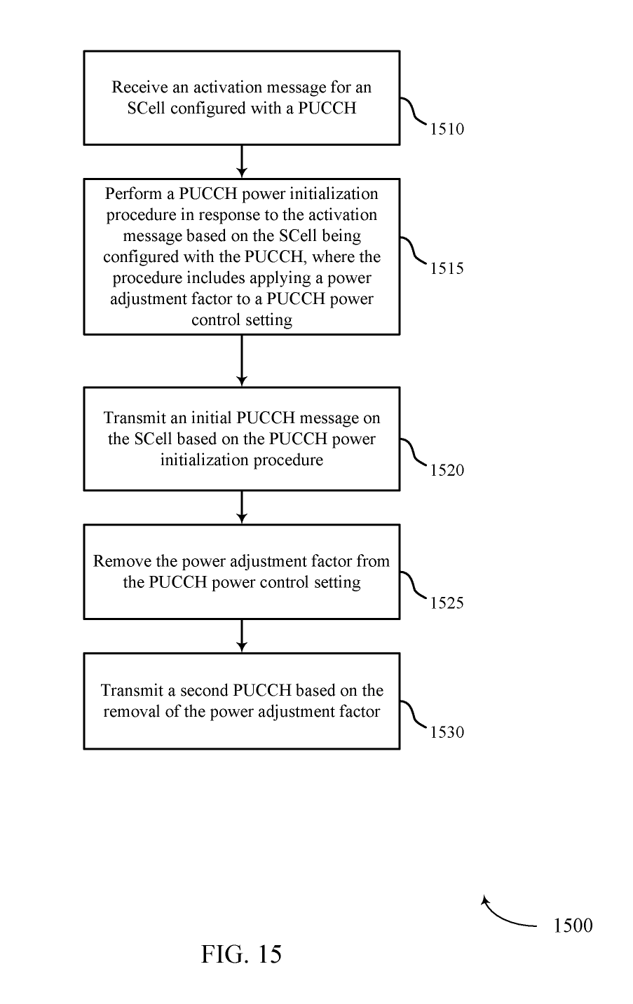

FIG. 15 shows a flowchart illustrating a method 1500 for PUCCH management for a PUCCH SCell in CA in accordance with various aspects of the present disclosure. The operations of method 1500 may be implemented by a UE 115 or its components as described with reference to FIGS. 1-12. For example, the operations of method 1500 may be performed by the PSCell PUCCH manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The UE 115 may establish or be configured for CA with a PCell and PUCCH-enabled SCell, as described with reference to FIGS. 2-4. The method 1500 may also incorporate aspects of methods 1300 and 1400 of FIGS. 13-14.

At block 1510, the UE 115 may receive an activation message for the SCell configured with the PUCCH as described with reference to FIGS. 2-4. In certain examples, the operations of block 1510 may be performed by the cell activation module 610 as described with reference to FIG. 6.

At block 1515, the UE 115 may perform a PUCCH power initialization procedure in response to the activation message based at least in part on the SCell being configured with the PUCCH as described with reference to FIGS. 2-4. In some cases, performing the PUCCH power initialization procedure includes: applying a power adjustment factor to a PUCCH power control setting. In certain examples, the operations of block 1515 may be performed by the PUCCH power initialization module 615 as described with reference to FIG. 6.

At block 1520, the UE 115 may transmit an initial PUCCH message on the SCell based at least in part on the PUCCH power initialization procedure as described with reference to FIGS. 2-4. In certain examples, the operations of block 1520 may be performed by the transmitter 515 as described with reference to FIG. 5.

At block 1525, the UE 115 may remove the power adjustment factor from the PUCCH power control setting as described with reference to FIGS. 2-4. In certain examples, the operations of block 1525 may be performed by the power adjustment module 705 as described with reference to FIG. 7.

At block 1530, the UE 115 may transmit a second PUCCH based at least in part on the removal of the power adjustment factor as described with reference to FIGS. 2-4. In certain examples, the operations of block 1530 may be performed by the transmitter 515 as described with reference to FIG. 5.

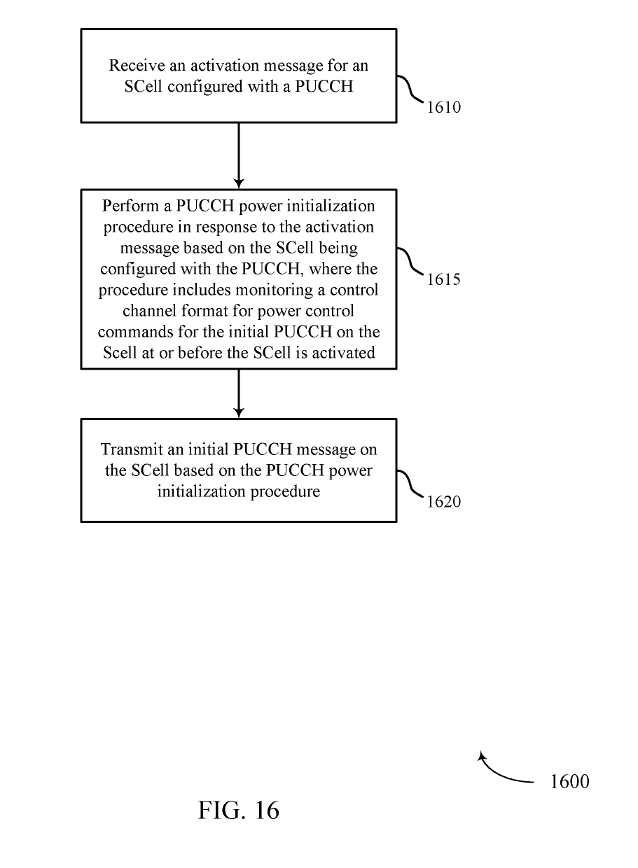

FIG. 16 shows a flowchart illustrating a method 1600 for PUCCH management for a PUCCH SCell in CA in accordance with various aspects of the present disclosure. The operations of method 1600 may be implemented by a UE 115 or its components as described with reference to FIGS. 1-12. For example, the operations of method 1600 may be performed by the PSCell PUCCH manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The UE 115 may establish or be configured for CA with a PCell and PUCCH-enabled SCell, as described with reference to FIGS. 2-4. The method 1600 may also incorporate aspects of methods 1300, 1400, and 1500 of FIGS. 13-15.

At block 1610, the UE 115 may receive an activation message for the SCell configured with the PUCCH as described with reference to FIGS. 2-4. In certain examples, the operations of block 1610 may be performed by the cell activation module 610 as described with reference to FIG. 6.

At block 1615, the UE 115 may perform a PUCCH power initialization procedure in response to the activation message based at least in part on the SCell being configured with the PUCCH as described with reference to FIGS. 2-4. In some cases, performing the PUCCH power initialization procedure includes monitoring at least one control channel format for power control commands for the initial PUCCH on the SCell at or before the SCell is activated. In certain examples, the operations of block 1615 may be performed by the PUCCH power initialization module 615 as described with reference to FIG. 6.

At block 1620, the UE 115 may transmit an initial PUCCH message on the SCell based at least in part on the PUCCH power initialization procedure as described with reference to FIGS. 2-4. In certain examples, the operations of block 1620 may be performed by the transmitter 515 as described with reference to FIG. 5.

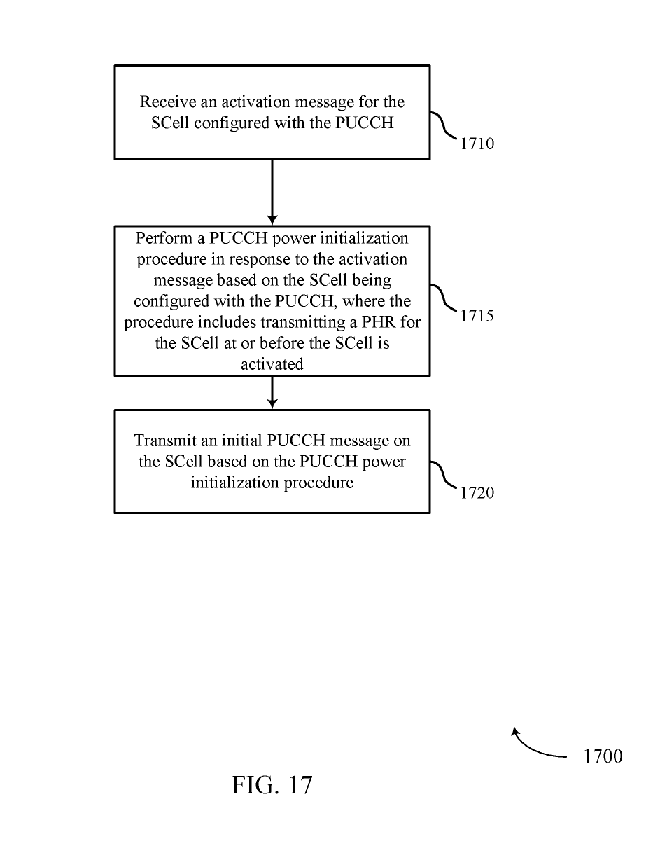

FIG. 17 shows a flowchart illustrating a method 1700 for PUCCH management for a PUCCH SCell in CA in accordance with various aspects of the present disclosure. The operations of method 1700 may be implemented by a UE 115 or its components as described with reference to FIGS. 1-12. For example, the operations of method 1700 may be performed by the PSCell PUCCH manager 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The UE 115 may establish or be configured for CA with a PCell and PUCCH-enabled SCell, as described with reference to FIGS. 2-4. The method 1700 may also incorporate aspects of methods 1300, 1400, 1500, and 1600 of FIGS. 13-16.

At block 1710, the UE 115 may receive an activation message for the SCell configured with the PUCCH as described with reference to FIGS. 2-4. In certain examples, the operations of block 1710 may be performed by the cell activation module 610 as described with reference to FIG. 6.

At block 1715, the UE 115 may perform a PUCCH power initialization procedure in response to the activation message based at least in part on the SCell being configured with the PUCCH as described with reference to FIGS. 2-4. In some cases, performing the PUCCH power initialization procedure includes transmitting a PHR for the SCell at or before the SCell is activated. In certain examples, the operations of block 1715 may be performed by the PUCCH power initialization module 615 as described with reference to FIG. 6.

At block 1720, the UE 115 may transmit an initial PUCCH message on the SCell based at least in part on the PUCCH power initialization procedure as described with reference to FIGS. 2-4. In certain examples, the operations of block 1720 may be performed by the transmitter 515 as described with reference to FIG. 5.

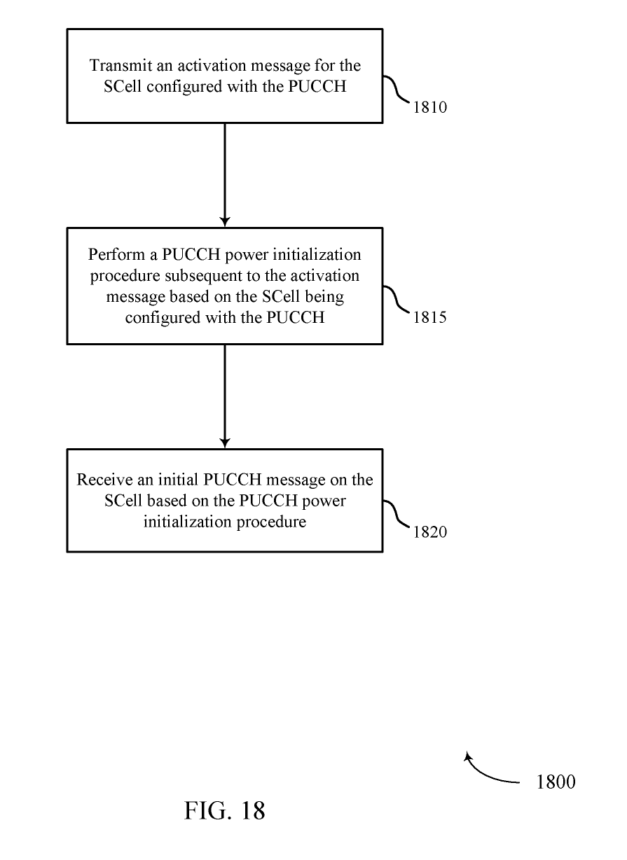

FIG. 18 shows a flowchart illustrating a method 1800 for PUCCH management for a PUCCH SCell in CA in accordance with various aspects of the present disclosure. The operations of method 1800 may be implemented by a base station 105 or its components as described with reference to FIGS. 1-12. For example, the operations of method 1800 may be performed by the base station PSCell PUCCH manager 910 as described with reference to FIGS. 9-12. In some examples, a base station 105 may execute a set of codes to control the functional elements of the base station 105 to perform the functions described below. Additionally or alternatively, the base station 105 may perform aspects the functions described below using special-purpose hardware. The UE 115 may establish or be configured for CA with a PCell and PUCCH-enabled SCell, as described with reference to FIGS. 2-4. The method 1800 may also incorporate aspects of methods 1300, 1400, 1500, 1600, and 1700 of FIGS. 13-17.

At block 1810, the base station 105 may transmit an activation message for the SCell configured with the PUCCH as described with reference to FIGS. 2-4. In certain examples, the operations of block 1810 may be performed by the BS cell activation module 1010 as described with reference to FIG. 10.

At block 1815, the base station 105 may perform a PUCCH power initialization procedure subsequent to the activation message based at least in part on the SCell being configured with the PUCCH as described with reference to FIGS. 2-4. In certain examples, the operations of block 1815 may be performed by the BS PUCCH power initialization module 1015 as described with reference to FIG. 10.

At block 1820, the base station 105 may receive an initial PUCCH message on the SCell based at least in part on the PUCCH power initialization procedure as described with reference to FIGS. 2-4. In certain examples, the operations of block 1820 may be performed by the receiver 905 as described with reference to FIG. 9.

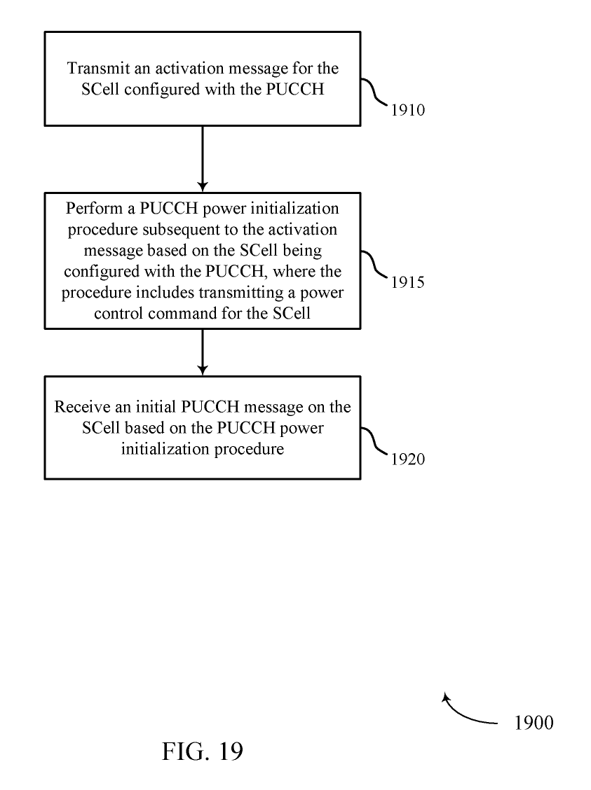

FIG. 19 shows a flowchart illustrating a method 1900 for PUCCH management for a PUCCH SCell in CA in accordance with various aspects of the present disclosure. The operations of method 1900 may be implemented by a base station 105 or its components as described with reference to FIGS. 1-12. For example, the operations of method 1900 may be performed by the base station PSCell PUCCH manager 910 as described with reference to FIGS. 9-12. In some examples, a base station 105 may execute a set of codes to control the functional elements of the base station 105 to perform the functions described below. Additionally or alternatively, the base station 105 may perform aspects the functions described below using special-purpose hardware. The UE 115 may establish or be configured for CA with a PCell and PUCCH-enabled SCell, as described with reference to FIGS. 2-4. The method 1900 may also incorporate aspects of methods 1300, 1400, 1500, 1600, 1700, and 1800 of FIGS. 13-18.

At block 1910, the base station 105 may transmit an activation message for the SCell configured with the PUCCH as described with reference to FIGS. 2-4. In certain examples, the operations of block 1910 may be performed by the BS cell activation module 1010 as described with reference to FIG. 10.

At block 1915, the base station 105 may perform a PUCCH power initialization procedure subsequent to the activation message based at least in part on the SCell being configured with the PUCCH as described with reference to FIGS. 2-4. In some cases, performing the PUCCH power initialization procedure includes transmitting a power control command for the SCell. In certain examples, the operations of block 1915 may be performed by the BS PUCCH power initialization module 1015 as described with reference to FIG. 10.

At block 1920, the base station 105 may receive an initial PUCCH message on the SCell based at least in part on the PUCCH power initialization procedure as described with reference to FIGS. 2-4. In certain examples, the operations of block 1920 may be performed by the receiver 905 as described with reference to FIG. 9.

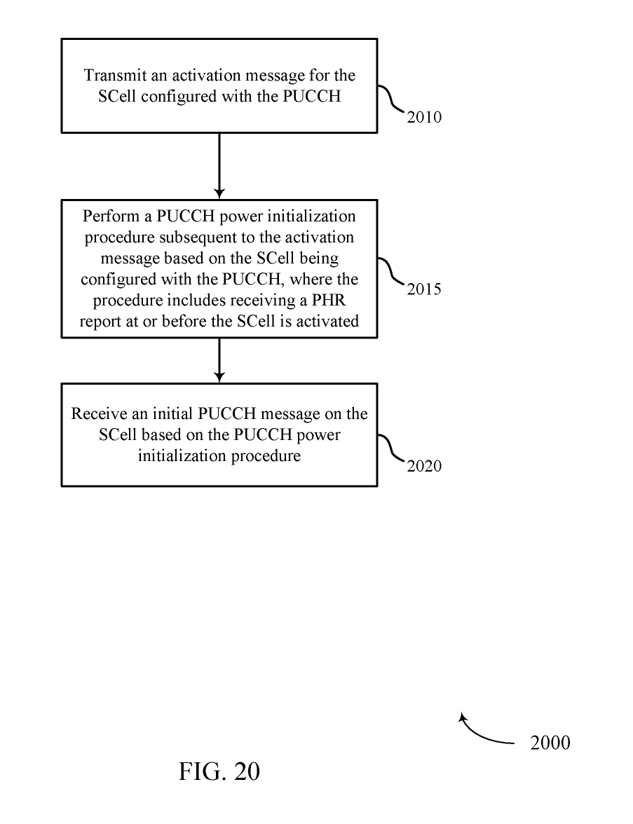

FIG. 20 shows a flowchart illustrating a method 2000 for PUCCH management for a PUCCH SCell in CA in accordance with various aspects of the present disclosure. The operations of method 2000 may be implemented by a base station 105 or its components as described with reference to FIGS. 1-12. For example, the operations of method 2000 may be performed by the base station PSCell PUCCH manager 910 as described with reference to FIGS. 9-12. In some examples, a base station 105 may execute a set of codes to control the functional elements of the base station 105 to perform the functions described below. Additionally or alternatively, the base station 105 may perform aspects the functions described below using special-purpose hardware. The UE 115 may establish or be configured for CA with a PCell and PUCCH-enabled SCell, as described with reference to FIGS. 2-4. The method 2000 may also incorporate aspects of methods 1300, 1400, 1500, 1600, 1700, 1800, and 1900 of FIGS. 13-19.

At block 2010, the base station 105 may transmit an activation message for the SCell configured with the PUCCH as described with reference to FIGS. 2-4. In certain examples, the operations of block 2010 may be performed by the BS cell activation module 1010 as described with reference to FIG. 10.

At block 2015, the base station 105 may perform a PUCCH power initialization procedure subsequent to the activation message based at least in part on the SCell being configured with the PUCCH as described with reference to FIGS. 2-4. In some cases, performing the PUCCH power initialization procedure includes receiving a PHR report at or before the SCell is activated. In certain examples, the operations of block 2015 may be performed by the BS PUCCH power initialization module 1015 as described with reference to FIG. 10.

At block 2020, the base station 105 may receive an initial PUCCH message on the SCell based at least in part on the PUCCH power initialization procedure as described with reference to FIGS. 2-4. In certain examples, the operations of block 2020 may be performed by the receiver 905 as described with reference to FIG. 9.

Thus, methods 1300, 1400, 1500, 1600, 1700, 1800, 1900, and 2000 may provide for PUCCH management for a PUCCH SCell in CA. It should be noted that methods 1300, 1400, 1500, 1600, 1700, 1800, 1900, and 2000 describe possible implementation, and that the operations and the steps may be rearranged or otherwise modified such that other implementations are possible. In some examples, aspects from two or more of the methods 1300, 1400, 1500, 1600, 1700, 1800, 1900, and 2000 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, Universal Mobile Telecommunications System (UMTS), LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for frequency division duplex (FDD) (e.g., frame structure type 1) and TDD (e.g., frame structure type 2).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer-readable storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication performed by a user equipment (UE) configured for carrier aggregation (CA) with a primary cell (PCell) and a physical uplink control channel (PUCCH) enabled secondary cell (SCell), comprising:
receiving an activation message for the SCell;
performing, in response to the activation message, a PUCCH power initialization procedure for the SCell, wherein the power initialization procedure comprises transmitting a power headroom report (PHR) for the SCell at or before activation of the SCell; and
transmitting an initial PUCCH message on the SCell based at least in part on the PUCCH power initialization procedure.

2. The method of claim 1, wherein performing the PUCCH power initialization procedure comprises:
determining a power activation level based at least in part on a PUCCH transmission power level of the SCell prior to a deactivation of the SCell.

3. The method of claim 1, wherein performing the PUCCH power initialization procedure comprises:
adjusting a power activation level in accordance with a power adjustment factor; and
wherein transmitting the initial PUCCH message on the SCell comprises transmitting the initial PUCCH message at the adjusted power activation level.

4. The method of claim 3, further comprising:
receiving a power adjustment message indicative of the power adjustment factor for transmissions on the PUCCH of the SCell in a medium access control (MAC) control element (CE), a physical downlink shared channel (PDSCH) transmission, a physical downlink control channel (PDCCH) transmission, an enhanced physical downlink control channel (ePDCCH) transmission, or any combination thereof.

5. The method of claim 3, further comprising:
selecting the power adjustment factor from a plurality of power adjustment factors.

6. The method of claim 1, wherein performing the PUCCH power initialization procedure comprises:
monitoring at least one control channel format for power control commands associated with transmitting the initial PUCCH message on the SCell at or before activation of the SCell.

7. The method of claim 6, wherein the at least one control channel format comprises a downlink control information (DCI) format 3 or a DCI format 3A, or both.

8. The method of claim 6, further comprising:
monitoring the at least one control channel format at or before activation of the SCell.

9. The method of claim 1, further comprising:
transmitting the PHR prior to activation of the SCell.

10. The method of claim 1, wherein the activation message is received as part of a reconfiguration procedure for the SCell.

11. An apparatus for wireless communication operable for carrier aggregation (CA) with a primary cell (PCell) and a physical uplink control channel (PUCCH)-enabled secondary cell (SCell), comprising:
a processor;
memory in electronic communication with the processor storing instructions which, when executed by the processor, configure the apparatus to:
receive an activation message for the SCell;
perform, in response to the activation message, a PUCCH power initialization procedure for the SCell, wherein the power initialization procedure comprises a transmission of a power headroom report (PHR) for the SCell at or before activation of the SCell; and
transmit an initial PUCCH message on the SCell based at least in part on the PUCCH power initialization procedure.

12. The apparatus of claim 11, wherein the instructions, when executed by the processor, configure the apparatus to:
determine a power activation level based at least in part on a PUCCH transmission power level of the SCell prior to a deactivation of the SCell.

13. The apparatus of claim 11, wherein the instructions, when executed by the processor, configure the apparatus to:
adjust a power activation level in accordance with a power adjustment factor; and
wherein transmitting the initial PUCCH message on the SCell comprises transmitting the initial PUCCH message at the adjusted power activation level.

14. The apparatus of claim 11, wherein performing the PUCCH power initialization procedure comprises:
monitoring at least one control channel format for power control commands associated with transmitting the initial PUCCH message on the SCell at or before activation of the SCell.

15. The apparatus of claim 11, wherein the activation message is received as part of a reconfiguration procedure for the SCell.

16. A non-transitory computer-readable medium storing code for wireless communication using a carrier aggregation (CA) configuration with a primary cell (PCell) and a physical uplink control channel (PUCCH)-enabled secondary cell (SCell), the code comprising instructions executable to:
receive an activation message for the SCell;
perform, in response to the activation message, a PUCCH power initialization procedure for the SCell, wherein the power initialization procedure comprises a transmission of a power headroom report (PHR) for the SCell at or before activation of the SCell; and
transmit an initial PUCCH message on the SCell based at least in part on the PUCCH power initialization procedure.

17. The non-transitory computer-readable medium of claim 16, wherein the instructions are executable to:
determine a power activation level based at least in part on a PUCCH transmission power level of the SCell prior to a deactivation of the SCell.

18. The non-transitory computer-readable medium of claim 16, wherein the instructions are executable to:
adjust a power activation level in accordance with a power adjustment factor; and
wherein transmitting the initial PUCCH message on the SCell comprises transmitting the initial PUCCH message at the adjusted power activation level.

19. The non-transitory computer-readable medium of claim 16, wherein performing the PUCCH power initialization procedure comprises:
monitoring at least one control channel format for power control commands associated with transmitting the initial PUCCH message on the SCell at or before activation of the SCell.

20. The non-transitory computer-readable medium of claim 16, wherein the activation message is received as part of a reconfiguration procedure for the SCell.
